(19) United States
(12) Patent Application Publication
(10) Pub. No.: US 2021/0266051 A1
(43) Pub. Date: Aug. 26, 2021

(54) WI-FI ACCESS POINT WITH BLUETOOTH BEACON

(71) Applicant: ZONEART NETWORKS LTD., Wales (GB)

(72) Inventor: Peter KENINGTON, Wales (GB)

(21) Appl. No.: 16/336,686

(22) PCT Filed: Sep. 13, 2017
(86) PCT No.: PCT/GB2017/000136

§ 371 Date: Mar. 26, 2019

(30) Foreign Application Priority Data
Sep. 27, 2016 (GB) 1616375.0

(51) Int. Cl. H04B 7/06; G01S 1/14; H04W 4/02; H04B 7/0456; H04W 4/80; H04W 64/00; H04B 17/309; H01Q 3/26

(52) U.S. Cl. CPC H04B 7/0617; G01S 1/14; H04W 4/023; H01Q 3/2605; H04W 4/80; H04W 64/003; H04B 17/309; H04B 7/0469

(57) ABSTRACT

A Bluetooth beacon system is described which is capable of forming a functionally-equivalent solution to a typical prior art Bluetooth beacon system but without the need to mount physical hardware devices at one or more explicit locations at which location-specific functionality, triggered by a Bluetooth beacon, is required. The Bluetooth beacon system consists of three elements: a Bluetooth module which is typically mounted remotely to the explicit location or locations at which location-specific functionality, triggered by a Bluetooth beacon, is required; a geolocation system capable of ascertaining the location of a user-equipment (UE) device and which may be based upon an infrastructure radio system and wherein the infrastructure radio system may incorporate a Bluetooth module; and a UE incorporating software functionality which is capable of both responding to one or more identification codes emitted from the Bluetooth module and receiving, deriving or interpreting its location relative to a known datum point.

### TECHNICAL FIELD

The present invention relates to Wi-Fi equipment and in particular to a Wi-Fi access point which is capable of accurately spatially locating and providing notifications or alerts to, for example, individual users of that access point via their user equipment or physical items which have been suitably equipped to interact with that access point.

### BACKGROUND

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

A Wi-Fi access point consists of one or more transmit channels, for sending digital information to an item of user equipment (UE) and one or more receive channels for receiving digital information from a UE. Items of user equipment can include: mobile telephony devices, tablet computers, ‘smart’ watches, laptop computers, assets or equipment with an attached or incorporated Wi-Fi ‘tag’ or any other item with an attached or included Wi-Fi transmit or receive capability.

A Wi-Fi access point communicates with any devices which have associated with that access point using protocols defined in an agreed standard. The main standard presently in use for this purpose is the 802.11 standard and its various amendments, for example 802.11a, 802.11b, 802.11g, 802.11n and 802.11ac, although any other suitable data communication standard could be employed, for example the HiperLAN standard. So long as both a Wi-Fi access point and a UE device both adhere to the same standard and suitable levels of the desired Wi-Fi signal and a sufficiently low level of interference exist in the immediate vicinity of both units, then communications between the Wi-Fi access point and the UE device should be possible.

Various mechanisms have been proposed in order to spatially locate a person or object by means of locating a radio device which is present in the vicinity of the person or object, for example a radio unit attached to the object or located on the user's person. One mechanism which has been proposed is to utilise modulated light, emanating from, for example, a light-emitting diode (LED) based lightbulb as a means for the UE to spatially locate itself within an area upon which that light falls. The light emanating from the bulb is picked up by a camera or other light sensor on the UE (with such cameras being commonly fitted to ‘smartphones’, for example) and by interpreting the data modulated onto the light, emanating from one or more suitably-equipped bulbs, the UE is able to ascertain its spatial position. This mechanism has the obvious disadvantages that it will not work if the UE is unable to see the modulated light, such as if the UE is carried in a pocket or handbag, or if other sources of light, such as sunlight, are stronger, masking the modulated light. A further disadvantage from the viewpoint of the infrastructure provider is that whilst the UE is enabled to determine its spatial location the infrastructure itself gains no knowledge of the UE's location, unless the UE is willing or enabled to divulge that information. This is a particular problem in security-related applications since the UE could be programmed to ‘lie’ and report a different location to the place at which it was actually located.

Another spatial location mechanism often deployed is that of beacons. These beacons typically operate using the Bluetooth standard, since the required receiving and decoding equipment is commonly available (again being frequently included in ‘smartphone’ mobile telephony devices). A typical beacon will operate using the Bluetooth Low Energy (BLE) protocol standard and will periodically transmit a short burst of data, at a low EIRP (effective isotropic radiated power) level, which identifies the presence of the beacon to a UE containing a suitably-equipped receiver (such as a smartphone) and communicates a numerical code to the receiver which uniquely identifies that beacon from others located in the same area, for example in a store or shopping mall. Based upon a digital code number received from the beacon, software associated with the receiver can ascertain the beacon's location within an area, by means of a downloaded table of locations, and then ascertain broadly how close the receiver is located to the beacon, for example within 1 m of the beacon, by means of a signal strength measurement undertaken by the receiver upon the beacon's transmission. Based upon this information, a UE can spatially locate itself within an area and, if appropriate, communicate this calculated location to an external system, via an available radio bearer, such as Wi-Fi or cellular. Note that here, again, the UE locates itself and the infrastructure has no knowledge of the UE's location unless the UE willingly divulges this information (and does so truthfully).

A beacon-based spatial location system also suffers from a number of drawbacks. The management and maintenance of a sufficiently large number of beacons to enable accurate spatial location over a reasonable area, such as a shopping mall, is significant. Many hundreds of beacons are required and, in order to keep purchase and installation costs low, beacons are typically battery-powered. Each beacon therefore needs to be monitored regularly, to ensure that it is still operational and, in many cases, still present; beacons need to be placed very close (often <1 m) to the people they are attempting to help to locate are therefore prone to theft. They are also frequently attached to their supporting surface, such as a wall, by some form of adhesive; when this fails, they fall off and are frequently lost.

Wi-Fi has also been employed to spatially locate users or objects. In a typical scenario, the Wi-Fi transmissions emanating from a UE are received by three or more Wi-Fi access points, with these access points being spatially-separated from each other by suitable distances in order to permit triangulation of the UE to be undertaken. An example scenario is shown in FIG. 1; in this figure, three Wi-Fi access points are shown, 101, 103 and 105, each with a corresponding locus of equal received signal strength, 102, 104 and 106, respectively. Each access point measures the strength of the signal received from the UE and conveys this information to a location-calculation algorithm. This algorithm assumes an appropriate propagation model for the signals emanating from an access point located in the relevant environment, such as a cluttered environment or an open, uncluttered environment. Based upon the chosen propagation model and the signal strength received from the UE, a radius is calculated at which the UE is likely to be located, generating a circular locus of possible points at which the UE could be located around the access point, for example locus 102 surrounding access point 101. This process is performed independently for the three access points 101, 103, 105, generating the corresponding loci 102, 104, 106. The algorithm then calculates the point at which these three loci intersect, 107, and this forms the calculated location of the UE.

Whilst this technique is sound, in theory, it has many practical drawbacks which severely limit the accuracy which may be obtained. For example, in a cluttered and dynamic environment, such as a shopping mall containing a number of customers who are actively mobile, the measured signal strength at each access point will vary dynamically as the environment changes, caused for example by the shoppers moving around. When this is combined with the fact that the theoretical variation of signal strength with distance, at other than very short distances from an access point, is very small for relatively large changes in distance, it is evident that small measurement errors in the signal strength, by one or more of the access points, can result in very large errors (10's of metres) in the spatial location reported by the algorithm.

A second Wi-Fi based spatial location technique involves the measurement of the difference in the signal propagation time from a UE to a number of antennas placed around the periphery of an access point. The access point implements an algorithm which searches, for example, for both the shortest propagation time and the longest propagation time for a given data burst to reach the antennas on the access point. It then assumes that the shortest propagation time corresponds to the antenna which is closest to the UE and the longest propagation time corresponds to the antenna which is furthest from the UE. The algorithm then traces a path from the antenna which registered the longest propagation time to the antenna which registered the shortest propagation time and this is interpreted to provide the bearing at which the UE sits relative to the access point. The propagation timing is then further interpreted to yield the distance at which the UE is located relative to the access point. The distance and bearing information is then combined with the known location of the access point to yield the spatial location of the UE.

Again, this approach has a number of disadvantages. Firstly, it is complex and large, typically requiring over 30 antennas to achieve a reasonable level of accuracy. Secondly, it is prone to misinterpreting information from reflected signals. Such signals will have a longer (often much longer) propagation time than will direct signals (which may be blocked by objects or people in a ‘real world’ environment). Any errors in this timing information can potentially severely impact both the bearing and distance calculations and thereby introduce significant errors into the reported spatial location.

### SUMMARY OF INVENTION

According to an aspect of the present invention, there is provided a wireless notification device for notifying user equipment within a coverage area, the wireless notification device comprising: a beamforming subsystem, a controller, an antenna array, a receiver, and a broadcasting subsystem;
the beamforming subsystem being coupled to the controller, the receiver and the antenna array, the beamforming subsystem being operable to process RF signals received from the user equipment by the antenna array and to provide the processed RF signals to the receiver to form at least two virtual antenna lobes, wherein processing the RF signals comprises varying at least one characteristic of the RF signals in response to control signals from the controller to vary at least one pointing angle of the at least two virtual antenna lobes such that the at least two virtual antenna lobes intersect;
wherein the controller is operable to determine a location of the user equipment based on the processed RF signals received by the receiver;
the broadcasting subsystem being operable to disseminate an identification code within the coverage area.

According to a further aspect of the present invention, there is provided a notification or alerting system to enable content to be provided to a remote user, via a remote device which is located within one or more defined regions within a coverage area, the notification system comprising:
An identification code transmitter which is capable of transmitting an identification code and which has a transmission range sufficient to enable it to adequately cover a coverage area;
A spatial location system which is capable of locating a remote device within a coverage area and communicating a location of the remote device to the remote device itself;
A remote device which is capable of receiving both location information from a spatial location system and an identification code transmitted by an identification code transmitter and undertaking a pre-determined course of action, or not, based upon the content of the identification code and the location information.

The spatial location system may comprise at least one of a transmitter and a receiver together with an antenna array wherein the antenna array is capable of varying a pointing angle of at least two antenna lobes independently under electronic control without the need to move either the antenna array or its constituent parts physically and wherein the at least two antenna lobes are arranged such that they may intersect at one or more pointing angles.

The antenna array may, for example, comprise at least a first sub-array and at least a second sub-array wherein the at least a second sub-array is oriented substantially orthogonally to the at least a first sub-array.

The at least a first sub-array may be arranged to generate at least a first lobe and the at least a second sub-array may be arranged to generate at least a second lobe wherein at least one of the first lobe and the second lobe has a shape which is substantially elongated in one plane and substantially narrower in a second, orthogonal, plane.

The at least a first lobe generated by the at least a first sub-array and the at least a second lobe generated by the at least a second sub-array may be arranged such that the direction in which the at least a first lobe is elongated is oriented substantially orthogonally to the direction in which the at least a second lobe is elongated.

The pointing angle of an antenna lobe of a first sub-array and the pointing angle of an antenna lobe of a second sub-array may be independently controllable in order to allow each to separately measure or locate a signal which falls within their respective steering ranges or to transmit a signal or signals for measurement by a remotely-located receiver.

The at least a first sub-array and the at least a second sub-array may be operably-coupled to at least a first transmitter and at least a second transmitter respectively or at least a first receiver and at least a second receiver respectively.

The at least a first sub-array and the at least a second sub-array may alternatively be operably-coupled to at least a first transceiver and at least a second transceiver respectively.

The antenna array may further comprise an antenna array control system which can provide independent electronic control of the pointing angle for each of at least two antenna lobes.

The antenna array control system may further comprise a measurement system which is operable to measure one or more of the strength, quality or data transfer capability of a signal received by or otherwise provided to the control system.

The antenna array control system may additionally comprise a data storage system which is operable to store one or more of the strength, quality or data transfer capability of a signal received by a remote transceiver and reported back to the control system.

The antenna array may further comprise a third sub-array which may be independently steerable by electronic means in order to control a pointing angle of a third antenna lobe which may also be used in a similar manner to that outlined above for the a first sub-array and the a second sub-array.

The antenna array control system may further comprise means to provide independent electronic control of the pointing angle of a third antenna lobe emanating from a third sub-array.

The antenna array control system may further comprise means to identify one or more spatial positions or regions at which or within which at least two of the at least three independently-steerable antenna beams intersects or overlaps in coverage.

The at least a third sub-array may be operably-coupled to at least a third transmitter or at least a third receiver. The at least a third sub-array may alternatively be operably-coupled to at least a third transceiver.

The identification code transmitter may comprise a Bluetooth transmitter circuit or a Bluetooth low-energy (BLE) transmitter circuit, together with an antenna element or antenna array wherein the antenna element or antenna array may be shared with any other transmitter or receiver forming a part of the notification or alerting system.

The identification code transmitter may be capable of transmitting a number of different identification codes and may be reconfigured either locally or remotely to effect a change of one or more identification codes which may be transmitted by the identification code transmitter, wherein the reconfiguration process may be manual, for example undertaken by a system administrator, or it may be automated.

The remote device may, for example, comprise a handheld device containing at least a Bluetooth receiver and a Wi-Fi transceiver.

The remote device may contain software or firmware which is capable of decoding an identification code and initiating a communication of content to a user by at least one of an auditory or a visual means.

According to a further aspect of the present invention, there is provided a method of notifying a user equipment within a coverage area, the method comprising:
processing RF signals received from the user equipment, to form at least two virtual antenna lobes,
wherein processing the RF signals comprises varying at least one characteristic of the RF signals in response to control signals to vary at least one pointing angle of the at least two virtual antenna lobes such that the at least two virtual antenna lobes intersect;
determining a location of the user equipment based on the processed RF signals; and
disseminating an identification code within the coverage area wherein the identification code is operable to notify the user equipment.

According to a further aspect of the present invention, there is provided a method of alerting a remotely-located device which is positioned within one or more defined regions within a coverage area, the method comprising:
Receiving, by the remotely-located device, an identification code which has been radiated throughout a coverage area;
Receiving, by the remotely-located device, information detailing a current or recent location of the remotely-located device within a coverage area;
Processing the identification code and the information detailing a current or recent location of the remotely-located device in order to determine if a pre-determined course of action, or not, should be undertaken by the remotely-located device.

The method may further incorporate the transmission of an identification code by a fixed infrastructure apparatus.

The method may further incorporate the provision of spatial location information regarding the location of the remotely-located device by at least a fixed infrastructure apparatus.

The method may further comprise the transmission of an identification code by radio means.

The method may further incorporate the derivation of spatial location information regarding the location of the remotely-located device by radio means.

The method may further incorporate the dissemination of spatial location information regarding the location of the remotely-located device by radio means.

The method may further comprise the receiving of RF signals from the user equipment at least in part by means of an antenna array.

The method may further comprise the processing of the RF signals being undertaken at least in part within a beamforming subsystem.

The method may further comprise the identification code being received by the user equipment wherein the user equipment undertakes or otherwise an action based upon the received identification code.

The method may further comprise the identification code being encoded within or otherwise utilising a Bluetooth or a Bluetooth Low Energy (BLE) carrier.

The method may further comprise the identification code identifying a physical object or item.

The method may further comprise the identification code identifying a location within the coverage area.

The method may further comprise the location of the user equipment being communicated to the user equipment.

The method may further comprise the location of the user equipment being wirelessly communicated to the user equipment by the wireless notification device.

The method may further comprise the broadcasting subsystem broadcasting a signal in accordance with at least an aspect of the Bluetooth or Bluetooth low-energy (BLE) standard.

### BRIEF DESCRIPTION OF THE DRAWINGS

For a better understanding of the present invention, and to show more clearly how it may be carried into effect, reference will now be made, by way of example, to the following drawings, in which:

FIG. 1 is an outline view of a network architecture showing overlapping lines of constant received signal strength;

FIG. 2 is a block diagram of an access point incorporating a beamforming system according to the present invention;

FIG. 3(a) is a schematic planar view of an antenna array;

FIG. 3(b) is a schematic planar view of an alternative antenna array;

FIG. 3(c) is a schematic planar view of a further alternative antenna array;

FIG. 3(d) is a schematic planar view of a still further alternative antenna array;

FIG. 4(a) shows a wireframe representation of a top view of an idealised approximation of an antenna radiation pattern of the form which could emanate from a horizontally-oriented linear multi-element antenna array;

FIG. 4(b) shows a wireframe representation of a side view of an idealised approximation of an antenna radiation pattern of the form which could emanate from a linear multi-element antenna array;

FIG. 4(c) shows a wireframe representation of a front (boresight) view of an idealised approximation of an antenna radiation pattern of the form which could emanate from a linear multi-element antenna array;

FIG. 4(d) shows a wireframe representational 3D view of an approximation of an idealised antenna radiation pattern of the form which could emanate from a linear multi-element antenna array;

FIG. 5(a) shows a wireframe representation of a rear (boresight) view of an approximation of two intersecting antenna radiation patterns of the form which could emanate from a horizontally-oriented linear multi-element antenna array and a vertically-oriented linear multi-element antenna array;

FIG. 5(b) shows a detail view of intersecting wireframe radiation patterns of a form shown in FIG. 5(a), highlighting a rectilinear area of intersection;

FIG. 5(c) illustrates the orientations of azimuth and elevation in relation to the diagrams shown in FIG. 5(a) and FIG. 5(b);

FIG. 6(a) shows a wireframe representation of a top view of a simplified, but representative, approximation of an antenna radiation pattern of the form which could emanate from a horizontally-oriented linear multi-element antenna array. The representation shown includes side-lobes and nulls in the radiation pattern;

FIG. 6(b) shows a three-dimensional wireframe representation of a simplified, but representative, approximation of an antenna radiation pattern of the form which could emanate from a linear multi-element antenna array. The representation shown includes side-lobes and nulls in the radiation pattern;

FIG. 7(a) is similar to FIG. 5(a) and shows a wireframe representation of a rear (boresight) view of an approximation of two intersecting antenna radiation patterns of a form which could emanate from a horizontally-oriented linear multi-element antenna array and a vertically-oriented linear multi-element antenna array. In FIG. 7(a), however, two loci of points representing peak gains of the two antenna array radiation patterns, at various offset angles from boresight in one plane, are clearly shown;

FIG. 7(b) shows a similar example situation to that of FIG. 7(a) however in this example a radiation pattern from an azimuth-oriented antenna array (not shown) is illustrated when pointing in a lower elevation altitude direction; this view therefore illustrates a different intersection location between the two loci shown;

FIG. 8 shows simplified 2D orthogonal radiation patterns emanating from two orthogonal antenna arrays placed on a ceiling of a room and radiating directly downward toward the floor of the room;

FIG. 9 shows example simplified orthogonal radiation patterns emanating from two orthogonal antenna arrays oriented to provide a downward-pointing angle between a wall and a ceiling of a room and radiating at an angle toward the floor of the room;

FIG. 10 shows a locus of the intersection between the two example simplified orthogonal radiation patterns shown in FIG. 9 and a projection of the intersection of the example simplified orthogonal radiation patterns themselves with the floor of the room;

FIG. 11(a) shows a similar situation to that of FIG. 6(a) with the exception that the beam has been steered approximately 15 degrees to the left of boresight. This figure illustrates a signal strength level reading which could be expected from a user located approximately on the original boresight position of the antenna array;

FIG. 11(b) shows a similar situation to that of FIG. 11(a) with the exception that the beam has now been steered approximately 10 degrees to the right of boresight. This figure illustrates a further signal strength level reading, obtained in this new steered direction, which could be expected from a user located approximately on the original boresight position of the antenna array. It also illustrates the difference between the signal strength values which could be obtained in the two steered positions illustrated in FIGS. 11(a) and 11(b);

FIG. 12 shows a flow-chart representation of an example method for determining an angle at which a UE is located relative to a known datum angle, for example a boresight angle of an antenna array;

FIG. 13 shows four different views of an example antenna array beam pattern as it is swept or scanned from left to right, covering a range of angles relative to the plane of an antenna array;

FIG. 13(a) shows a first example beam location for a swept or scanned antenna beam;

FIG. 13(b) shows a second example beam location for a swept or scanned antenna beam;

FIG. 13(c) shows a third example beam location for a swept or scanned antenna beam;

FIG. 13(d) shows a fourth example beam location for a swept or scanned antenna beam;

FIG. 14 shows a flow chart representation of one embodiment of a method of locating a UE;

FIG. 15 shows a flow chart representation of a further embodiment of a method of locating a UE;

FIG. 16(a) shows an example of a reference antenna beam pattern;

FIG. 16(b) shows an example of an antenna beam pattern of a type which could result from measurements taken using an in-situ (installed) receiver or transceiver system incorporating a steerable antenna system, in a representative physical environment;

FIG. 16(c) shows an example result achieved when performing one form of correlation processing using the example antenna beam patterns shown in FIG. 16(a) and FIG. 16(b);

FIG. 17 shows a flow chart representation of a still further embodiment of a method of locating a UE;

FIG. 18(a) shows an example of a reference antenna beam pattern;

FIG. 18(b) shows a coarsely quantised example of an antenna beam pattern of a type which could result from measurements taken using an in-situ (installed) receiver or transceiver system incorporating a steerable antenna system, in a representative physical environment;

FIG. 18(c) shows an example result achieved when performing one form of correlation processing using the example antenna beam patterns shown in FIG. 18(a) and FIG. 18(b);

FIG. 19 illustrates some example differences in coverage and utility between a conventional Bluetooth low-energy (BLE) beacon installation and a virtual BLE beacon system according to one aspect of the present invention;

FIG. 20 shows the key elements of an example virtual BLE beacon system according to one aspect of the present invention.

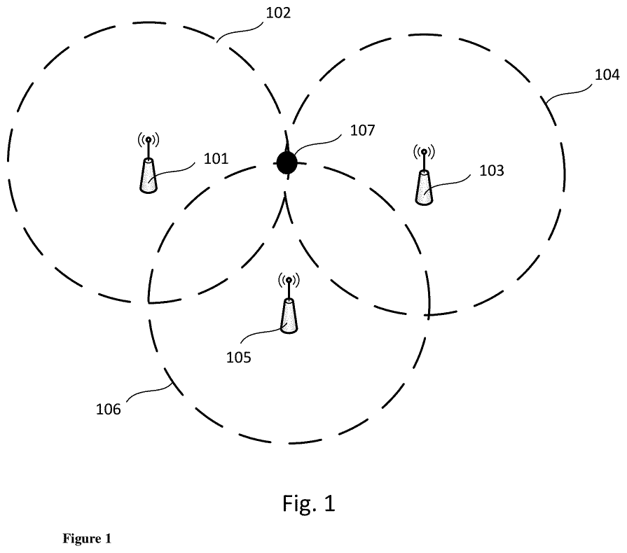

### DETAILED DESCRIPTION

An example of a ‘virtual’ Bluetooth beacon system, which is capable of replicating the essential functionality associated with placing one or more Bluetooth beacons at any point within its coverage area, will now be described with reference to the accompanying drawings. The virtual Bluetooth beacon system to be described may make use of the Bluetooth Low Energy (BLE) protocol and may make use of hardware, including integrated circuits, which has been designed for use with that protocol standard. Beacons designed to utilise the BLE protocol and which adhere to other aspects of the associated standards are typically referred to as BLE beacons.

The virtual Bluetooth beacon system to be described herein consists of three main elements:
a) One or more BLE modules or circuits which emit BLE protocol-compliant signals incorporating one or more pre-set identification codes—these may be referred to as one or more broadcasting subsystem which are operable to broadcast BLE protocol-compliant signals over a coverage area;
b) A geolocation system which enables a user equipment (UE) to ascertain its location within a coverage area of an infrastructure radio system which incorporates one or more BLE modules or circuits;
c) A UE incorporating a radio receiver which is capable of receiving radio signals from the infrastructure radio system, interpreting those signals to ascertain its location within a coverage area of the infrastructure radio system and running a software program in response to one or more identification codes emitted by a BLE module.

Example embodiments of these three elements will now be described in more detail, starting with an example of an infrastructure radio system which may form part or all of a geolocation system. In the example embodiment described below, the infrastructure radio system may spatially locate a UE and may then inform the UE of the UE's own location. Whilst this is a valid option, it is also possible that the UE may be able to calculate its own location, based upon signals transmitted by the infrastructure radio system or by any other means.

An infrastructure radio system which may be capable of accurate geolocation may be formed using, for example, one or more Wi-Fi access points, as will now be described.

An access point to be described is capable of accurate geolocation without necessarily requiring any additional information from other, neighbouring, access points, for example signal strength measurement information of the signal strength received from a UE at a location within the coverage area of a second access point and measured by that second access point. Furthermore, the access point to be described is capable of accurate geolocation without requiring a distance or range calculation of the range or distance of the UE from the access point using, for example, signal strength information or signal propagation time information. Eliminating the need to calculate the distance at which a UE is located relative to the position of an access point is a significant benefit of the access point to be described herein, since it eliminates the main sources of error in utilising prior art access points for geolocation purposes.

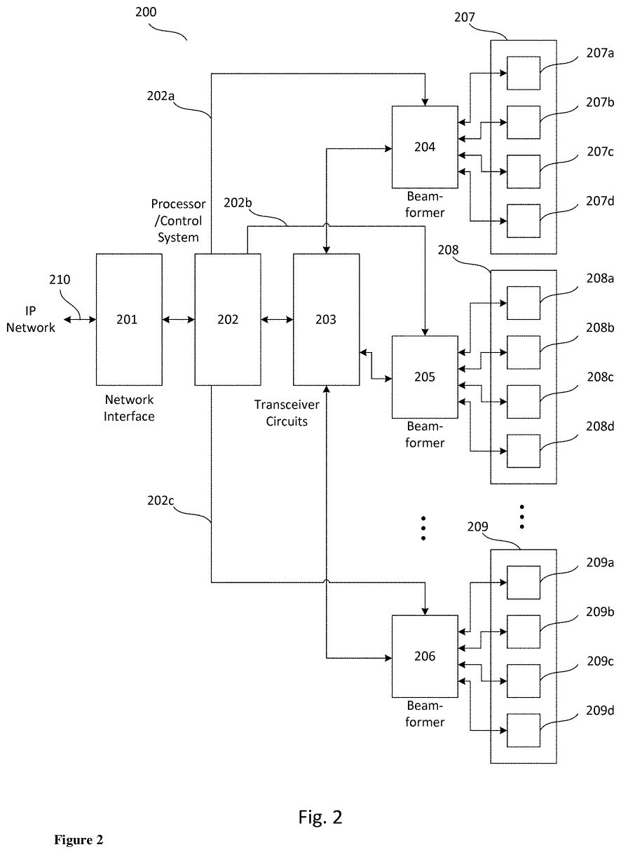

An example of the form of an access point 200 which is capable of accurate geolocation and an extended coverage range is shown in FIG. 2. The access point connects to a data network, for example an Internet Protocol (IP) network, via an interconnection 210, which could, for example, take the form of a CAT5, CAT5e or CAT6 cable or a fibre-optic cable or any other suitable connection means.

Network data signals are transmitted over a data network and received from a data network by means of network interface 201. Network interface 201 translates the data signals to and from a network protocol, such as the Internet Protocol, and feeds user data and other data to a processor/control system (or controller) 202. This processor/control system fulfils at least two primary functions: firstly it performs further processing upon user and other data received from network interface 201 and passes this further processed data to transceiver circuits 203 as well as, separately, processing the data received from transceiver circuits 203 and performing processing on this data before feeding it to network interface 201; secondly it generates control signals which are fed to beam-forming subsystems 204, 205 and 206. In many access point implementations, processor/control system 202 and transceiver circuits 203 are implemented as integrated circuits and in some of these implementations processor/control system 202 and transceiver circuits 203 are integrated into the same integrated circuit.

The example of an access point system provided in FIG. 2 shows three beamforming subsystems 204, 205 and 206, however this should not be taken as a limiting example and a greater or a lesser number of beamforming subsystems may be controlled by processor/control system 202. Specifically, in an example configuration in which transceiver circuits 203 consist of 4×4 multiple-input, multiple-output (MIMO) transceiver circuits, then up to four beam-forming subsystems could be connected to processor/control system 202. Likewise, in a further example configuration in which transceiver circuits 203 consist of 2×2 multiple-input, multiple-output (MIMO) transceiver circuits, then as few as two beam-forming subsystems may be connected to processor/control system 202.

Beamforming subsystems 204, 205 and 206 are connected to antenna elements forming antenna arrays 207, 208 and 209 respectively. For example, beam-forming subsystem 204 connects to antenna elements 207a, 207b, 207c and 207d in antenna array 207. Likewise, beam-forming subsystem 205 connects to antenna elements 208a, 208b, 208c and 208d in antenna array 208 and beam-forming subsystem 206 connects to antenna elements 209a, 209b, 209c and 209d in antenna array 209. The operation of beamforming subsystems 204, 205 and 206, together with antenna arrays 207, 208 and 209 and transceiver circuits 203 will be described in more detail below.

In one embodiment, transceiver circuits 203 could consist of digital transmitter and receiver circuits which act to form digital representations of modulated signals to be transmitted, in their transmit circuitry, or to decode or demodulate digital representations of modulated received signals, in their receive circuitry. In this embodiment, signals transmitted to and received from beam-formers 204, 205 and 206 could be digital signals and the beam-formers 204, 205 and 206 could be digital beam-formers, in which amplitude and/or phase weightings are imposed upon the signals they process digitally (separately or together in either transmit or receive directions), for example by means of digital multiplication of these amplitude and phase weightings with digital representations of the signals passing through the beam-formers, in order to present signals which, when converted to or from analogue form, serve to point the beams formed by antenna arrays 207, 208 and 209 in one or more desired directions.

In another embodiment, transceiver circuits 203 could consist of both digital and analogue transmitter and receiver circuits which act to form analogue modulated signals to be transmitted, in their transmit circuitry, or to decode or demodulate analogue modulated received signals, in their receive circuitry. In this embodiment, signals transmitted to and received from beamformers 204, 205 and 206 could be analogue signals and the beamformers 204, 205 and 206 could be analogue beam-formers, in which amplitude and/or phase weightings are imposed upon the signals they process using passive or active analogue signal processing techniques (separately or together in either transmit or receive directions), for example by means of a Rotman Lens, a Butler Matrix, a Blass Matrix or a Nolen Matrix or any other suitable circuit configuration as is known in the art, in order to present signals which serve to point the beams formed by antenna arrays 207, 208 and 209 in one or more desired directions.

In one embodiment, processor/control system 202 may provide beam position information, coefficients or co-ordinates, in the form of gain, amplitude or phase weightings, in-phase and quadrature weightings, or any other suitable mechanism and in a suitable format such that beam-formers 204, 205 and 206 can direct one or more beams emanating from antenna arrays 207, 208 and/or 209 in directions determined by the processor/control system 202. In this way, processor/control system 202 is able to control the direction of beams formed by beam-formers 204, 205 and 206 in either or both of transmit and receive directions and is further capable of steering beams in different directions for transmit and receive signals from the same antenna array by means of applying different beam-forming coefficients to received signals than those applied to transmit signals. This may be possible, without recourse to duplex or diplex filtering of transmit and receive signals, since many systems, for example Wi-Fi systems, such as those based upon the IEEE 802.11 standards, utilise a time-division duplex (TDD) protocol with transmission and reception times being divided into separate time-slots or frames and it is therefore possible to select different beam-steering coefficients during receive time-slots to those used during transmit time-slots. Furthermore, it is possible to steer individual transmit and receive beams to individual UEs, since each time-slot, from a given access point, is typically dedicated to transmitting signals to or receiving signals from a single UE.

Take, as an example, an access point AP#1 which has two UEs: UE#1 and UE#2, associated with it. Both UEs are assumed to be actively transmitting and receiving data from the access point quasi-simultaneously. UE#1 transmits its first data packet to access point AP#1 in time-slot #1 and beamformers 204, 205 and 206 accept beam-steering coefficients 204-UE#1-Rx, 205-UE#1-Rx and 206-UE#1-Rx respectively. It is not necessary that the beams formed by the three arrays 207, 208 and 209 point in the same or a similar direction as each other; it may be, for example, that one or more beams are directed to receive one or more strong reflected signals from UE#1 rather than a direct signal.

In time-slot #2, UE#2 is expecting to receive its first data packet from access point AP#1 and beamformers 204, 205 and 206 in access point AP#1 accept beam-steering coefficients 204-UE#2-Tx, 205-UE#2-Tx and 206-UE#2-Tx respectively, which act to direct transmit beams from access point AP#1 to best serve UE#2 with its intended data packet. Again, beams formed by the three arrays 207, 208 and 209 may not point in the same direction as each other.

In time-slot #3, UE#1 is expecting to receive its first data packet from access point AP#1 and beamformer 204, 205 and 206 in access point AP#1 accept beam-steering coefficients 204-UE#1-Tx, 205-UE#1-Tx and 206-UE#1-Tx respectively, which act to direct transmit beams from access point AP#1 to best serve UE#1 with its intended data packet. Again, beams formed by the three arrays 207, 208 and 209 may not point in the same direction as each other.

In time-slot #4, UE#2 is expecting to transmit its first data packet from access point AP#1 and the beam-formers 204, 205 and 206 in access point AP#1 accept beam-steering coefficients 204-UE#2-Rx, 205-UE#2-Rx and 206-UE#2-Rx respectively, which act to direct transmit beams from access point AP#1 to best receive a data packet from UE#2. Again, beams formed by the three arrays 207, 208 and 209 may not point in the same direction as each other.

This process of beam-steering to best serve UEs in respect of their transmitted and received data packets can continue in a similar manner, utilising different or the same beam-steering coefficients for each UE and different or the same beam-steering coefficients for transmit (downlink) or receive (uplink) signals. Note that the order of transmit and receive data packets outlined above is not proscriptive. For example, it may be that two or more downlink data packets occur directed at a single UE or separately at more than one UE and that these packets are consecutive, with no intervening uplink data packet. Likewise, it may be that two or more uplink data packets occur directed at a single UE or separately at more than one UE and that these packets are consecutive, with no intervening downlink data packet. Beamforming coefficients may be assigned to each packet in the manner outlined above, with different or the same coefficients being used in the uplink or downlink directions and different or the same coefficients being used for one or more UEs.

The above discussion has been simplified for clarity and does not include discussion of any broadcast packets, such as beacon packets, any acknowledgement packets and the like.

A further aspect of the beam-steering system described above is that individual beams formed by each separate antenna array 207, 208, 209 may be formed simultaneously when considering a MIMO transmitter and receiver system, which is typical of most higher-performance Wi-Fi access points. So, for example, antenna array 207 may be connected to MIMO transmit/receive channel M1, antenna array 208 may be connected to MIMO transmit/receive channel M2 and antenna array 209 may be connected to MIMO transmit/receive channel M3. Channels M1, M2 and M3 will typically act in unison, from a transmit/receive perspective, for example, if a block of data is being sent to UE#1, then channel M1 will be used to transmit some or all of that block of data, likewise, channel M2 will also be used to transmit some or all of that block of data simultaneously with the corresponding transmission of some or all of the same block of data from channel M1 and channel M3 will further be used to transmit some or all of the same block of data simultaneously with the corresponding transmissions of some or all of the same block of data from channels M1 and M2. Thus, three antenna beams can be formed simultaneously, one for each of channel M1, channel M2 and channel M3, in a given transmit or receive time-slot, all serving the same UE. It is this simultaneous forming of independently-steerable beams, from a single access point, transmitting one or more data packets to a single UE, which is a key enabling aspect of the high-accuracy geolocation system to be described below.

The above discussion has highlighted one example method by which multiple, individual, beams may be directed toward a single UE. It has illustrated the principle based upon a 3×3 MIMO access point example, as three MIMO channels and three beams were discussed. It is evident that three MIMO channels is not a limiting case and that beam-steering of a single channel, two channels (2×2 MIMO) and four or more channels (4×4 MIMO and above) are also possible.

Likewise the example of using Wi-Fi as the bearer to transmit and receive data from a UE is not a limiting case and other time-division duplex, frequency-division duplex and code-division duplex air interfaces or bearers may be used, together with appropriately-designed beam-formers and antenna arrays, involving duplex filtering when appropriate.

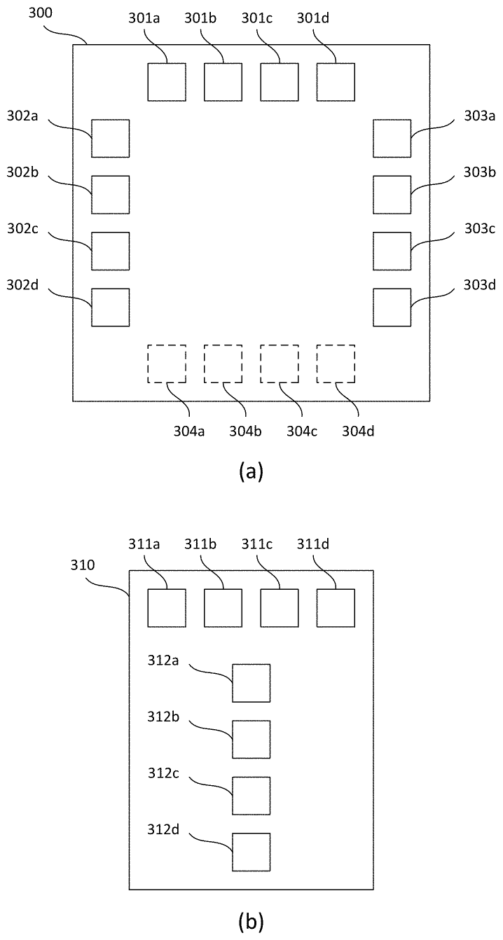

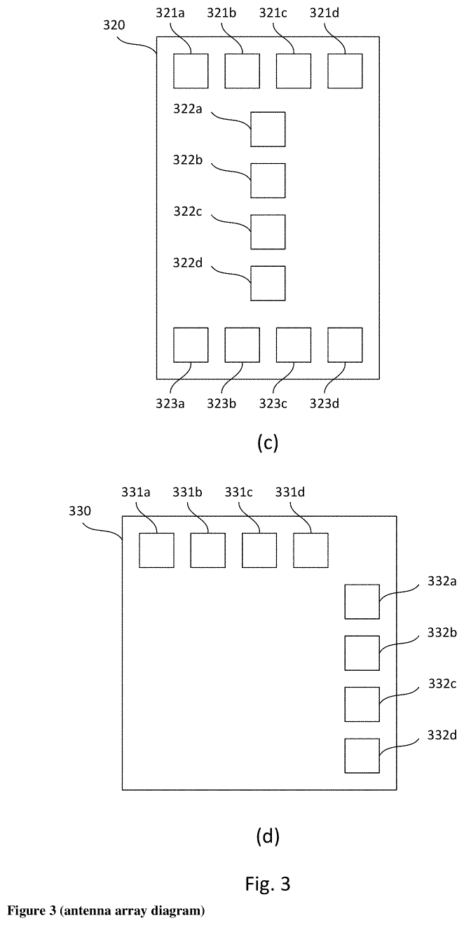

In order to utilise the above-discussed or similar beam-forming techniques for spatial location or geolocation purposes, the configuration and orientation of the beam-forming antenna arrays 207, 208 and 209 is important. This aspect of the system will now be discussed with reference to FIG. 3.

Combined antenna array 300, shown in FIG. 3(a), consists of three main arrays corresponding to an intended application in a 3×3 MIMO system and an optional fourth array which could be employed where a 4×4 MIMO system is required. The three main arrays are formed as follows: array #1 consists of antenna elements 301a, 301b, 301c and 301d; array #2 consists of antenna elements 302a, 302b, 302c and 302d; array #3 consists of antenna elements 303a, 303b, 303c and 303d and optional array #4 consists of antenna elements 304a, 304b, 304c and 304d. In FIG. 3(a), the antenna arrays are configured in an approximately square arrangement, with four antenna elements corresponding to a single antenna array and each antenna array is arranged to be oriented in a perpendicular direction to its neighbouring arrays, to form combined antenna array 300.

It should be appreciated that although antenna arrays of four elements each are shown in FIG. 3(a), with a total combined antenna array size of 16 elements being shown in that figure, arrays of other sizes, numbers of elements and configurations are possible, some of which will be outlined below. Individual antenna arrays consisting of larger numbers of elements will typically result in a narrower main lobe beam being formed by each individual antenna array, when fed with suitably-phased signals as provided by one of the beam-formers 207, 208, 209 of FIG. 2 and assuming that the spacing between the individual antenna elements is similar in both cases. Likewise, individual antenna arrays consisting of smaller numbers of elements will typically result in a broader main lobe beam being formed by each individual antenna array, when fed with suitably-phased signals as provided by one of the beam-formers 207, 208, 209 of FIG. 2 and assuming that the spacing between the individual antenna elements is again similar in both cases. Other, typical, individual antenna array sizes could be, for example, two elements (giving a combined antenna array 300 size of, for example, 8 elements for a 4×4 MIMO system), eight elements (giving a combined antenna array 300 size of, for example, 32 elements for a 4×4 MIMO system) and sixteen elements (giving a combined antenna array 300 size of, for example, 64 elements for a 4×4 MIMO system) although other options are also possible.

The individual antenna elements, for example antenna elements 301a to 301d, 302a to 302d, 303a to 303d, 304a to 304d, shown in FIG. 3(a) can be implemented in a wide variety of ways, including as: microstrip patch elements, air-spaced patch elements, dielectric-spaced (e.g. insulating foam spaced) patch elements, monopole antennas, dipole antennas, helical antennas, dielectric resonator antennas, ‘chip’ dielectric antennas, inverted-F type antennas, Yagi antennas with any number of directors and/or reflectors and whether formed from wire, etched copper on a dielectric substrate or rigid metal structures, horn antennas, reflector/dish-based antennas, wire antennas or any other form of antenna element whether linearly, circularly, slant or otherwise polarised. The main stipulations for these antenna elements are that, within a given antenna array, they should be capable of emanating or receiving signals which combine coherently to form a recognised beam shape and which permit the beam to be manipulated by means of altering the amplitude and/or phase of one or more of the signals feeding, or being sourced from, one or more of the antenna elements. In this instance, ‘manipulated’ is defined as some or all of altering the shape, make-up including the number of lobes, side-lobes, nulls and other beam characteristics, and pointing direction of a main lobe, a side-lobe or a null of at least one of the transmit and receive beam characteristics.

Returning now to combined antenna array 300, shown in FIG. 3(a), and which can be seen to consist of three main antenna arrays (excluding elements 304a, 304b, 304c and 304d shown using dashed lines in FIG. 3(a)) as discussed above for example when considering an intended application in a 3×3 MIMO system. It can be seen that array #1, consisting of antenna elements 301a, 301b, 301c and 301d, and array #2 consisting of antenna elements 302a, 302b, 302c and 302d, are arranged orthogonally to one another. Likewise array #1, consisting of antenna elements 301a, 301b, 301c and 301d, and array #3 consisting of antenna elements 303a, 303b, 303c and 303d, are arranged orthogonally to one another. This configuration, shown in FIG. 3(a), may typically yield beams and beam patterns which are orthogonal to one another, specifically a beam pattern emanating from array #1 will typically be orthogonal to a corresponding beam pattern emanating from array #2; likewise, a beam pattern emanating from array #1 will typically be orthogonal to a corresponding beam pattern emanating from array #3. Such orthogonality is not limited to orthogonality of polarisation, which may or may not result of an orthogonality of array orientation, depending upon how the individual antenna elements for example 301a, 301b, 301c and 301d and 302a, 302b, 302c and 302d are driven from a polarisation perspective, it will also encompass or exclusively encompass the shape of the respective beams or beam patterns. For example, if array #1, consisting of antenna elements 301a, 301b, 301c and 301d were to form a main lobe which was substantially broader in the elevation plane than it was in the azimuth plane, then array #2, consisting of antenna elements 302a, 302b, 302c and 302d and which is of similar construction to array #1 but with a vertical arrangement of elements rather than the horizontal arrangement shown in the case of array #1, could form a main lobe which was substantially broader in the azimuth plane than it was in the elevation plane. Likewise, in this example, array #3 which consists of antenna elements 302a, 302b, 302c and 302d and which is again of similar construction to array #1 but with a vertical arrangement of elements rather than the horizontal arrangement shown in the case of array #1, could form a main lobe which was again substantially broader in the azimuth plane than it was in the elevation plane.

It should be remembered that these three beams, with their respective main lobe shapes, emanating from array #1, array #2 and array #3 respectively, are typically formed, simultaneously, from independent transmission streams, one for each of the three MIMO channels in this example, and are not typically formed from three identical copies of the same transmission stream, although this example should not be taken as limiting to the invention described herein. These three transmission streams can therefore be analysed independently by the UE, if it has such capabilities. For example, signal strength values can be measured for each of the three streams independently. Likewise, transmissions from the UE, even single-stream transmissions in the case where a UE is not configured to generate 3×3 or 2×2 MIMO signals, will be received independently by the three MIMO antenna arrays making up combined array 300. Each of the three main antenna arrays, 301a-301d, 302a-302d, 303a-303d, making up combined array 300 can measure the strength of a signal emanating from the (or each) UE and thereby judge from what angle to boresight, a main lobe, a side-lobe or a null the UE's transmission is emanating, as will be outlined below. The ability to make two or more (three in the above example) independent signal strength measurements, from two or more (three in the above example) independent antenna arrays any of at least two of which are at least one of being orthogonal to each other and capable of generating orthogonal beam pattern shapes, is a unique benefit of the access point disclosed here and one aspect of forming a spatial location capability using a single access point.

FIG. 3(b) shows an alternative form 310 of an antenna array according to a further aspect of the present invention. The arrangement shown in FIG. 3(b) can illustrate at least three different options: a 2×2 MIMO configuration with orthogonal beam pattern shapes; a 3×3 MIMO configuration with at least two orthogonal beam pattern shapes and a 4×4 MIMO configuration with at least two orthogonal beam pattern shapes, as will now be described.

Taking the 2×2 MIMO case, antenna elements 311a, 311b, 311c and 311d form antenna array #11 and antenna elements 312a, 312b, 312c and 312d form antenna array #12; antenna array #11 and antenna array #12 are similar arrays, with antenna array #11 being mounted orthogonally to antenna array #12. Both antenna array #11 and antenna array #12 are typically, although not necessarily, single polarisation arrays consisting of single-polar antenna elements, 311a, 311b, 311c, 311d and 312a, 312b, 312c, 312d respectively. Combined array 310 is therefore capable of fulfilling, in conjunction with one or more beam-formers and other elements of an access point, the desired aims of, at least, generating independently-steerable, orthogonal, beam-pattern shapes an elevation beam-pattern of which is significantly different to that of a corresponding azimuth beam-pattern, simultaneously from at least two independent transmission or reception streams, such as MIMO channels.

Taking now the 3×3 MIMO case, antenna elements 311a, 311b, 311c and 311d for example now form two antenna arrays which are now required to radiate two polarisations simultaneously, antenna array #11A and antenna array #11B, with antenna array #11A having, say, vertical polarisation and antenna array #11B having horizontal polarisation and antenna elements 312a, 312b, 312c and 312d, forming antenna array #12, a single-polarisation array, as before. Antenna array #11A and antenna array #11B would typically share the same radiating elements as shown in FIG. 3(b), although this need not always be the case for example if crossed-dipole or crossed Yagi antenna elements are used; the two co-located antenna arrays would typically be distinguished by utilising separate feed-systems, to achieve two orthogonal polarisations for the electromagnetic waves emanating from the radiating element(s), with suitable antenna element and feed-system designs including, but not limited to: dual-probe fed patch antennas, dual-aperture fed patch antennas, crossed-dipole antennas, crossed-Yagi antennas, left and right-hand circular polarisation radiating structures and any other suitable structures capable of generating two substantially orthogonal polarisations.

Antenna array #11, consisting of antenna array #11A and antenna array #11B, and antenna array #12 are ostensibly similar arrays to one another, excepting the features discussed above, a key difference being, however, that antenna array #11 is oriented orthogonally to antenna array #12. Antenna array 310 is therefore capable of fulfilling, in conjunction with one or more beam-formers and other elements of an access point, the desired aims of, at least, generating independently-steerable, orthogonal, beam-pattern shapes the elevation beam-pattern of which is significantly different to that of the corresponding azimuth beam-pattern, simultaneously from at least two (and in this case, three) independent transmission or reception streams, such as MIMO channels.

A further embodiment, similar in operation to that just described, consists of a single-polarisation array, antenna array #11, formed from antenna elements 311a, 311b, 311c, 311d and a dual-polarisation array, consisting of antenna array #12a and antenna array #12b and comprising antenna elements 312a, 312b, 312c, 312d which are now required to radiate two polarisations simultaneously. In effect, this embodiment simply swaps the dual-polarisation aspects of the earlier embodiment from antenna elements 311a, 311b, 311c and 311d to antenna elements 312a, 312b, 312c and 312d. In other respects operation is similar to that just described.

A yet further embodiment, which can also be illustrated by FIG. 3(b), involves the use of two dual-polarisation antenna arrays, with each array/polarisation being fed by a separate MIMO channel in say a 4×4 MIMO system implementation. Dual-polar antenna array #11 consists of, for example, vertical polarisation antenna array #11A and horizontal polarisation antenna array #11B, both of which are formed using antenna elements 311a, 311b, 311c and 311d which are capable of radiating electromagnetic waves in both polarisations simultaneously. Dual-polar antenna array #12 consists of, for example, vertical polarisation antenna array #12A and horizontal polarisation antenna array #12B, both of which are formed using antenna elements 312a, 312b, 312c and 312d which are also capable of radiating electromagnetic waves in both polarisations simultaneously. The operation of this combined antenna array is similar to that discussed above in relation to the 3×3 MIMO example, however now with an extra MIMO channel and an extra polarisation with which to accommodate that channel Any two polarised beams with typically one each from a vertically-oriented array consisting of antenna elements 312a, 312b, 312c, 312d and a horizontally-oriented array consisting of antenna elements 311a, 311b, 311c, 311d, are capable of fulfilling, in conjunction with one or more beamformers and other elements of an access point, the desired aims of, at least, generating independently-steerable, orthogonal, beam-pattern shapes an elevation beam-pattern of which is significantly different to that of a corresponding azimuth beam-pattern, simultaneously from at least two (and in this case, three) independent transmission or reception streams, such as MIMO channels.

Whilst the embodiments described above discuss the formation of orthogonal linear polarisations utilising two feed systems in antenna array #11 or antenna array #12 or both, it is also possible to utilise orthogonal circular polarisations, such as left-hand and right-hand circular polarisation, to achieve the same goal.

The above embodiments discuss specific ‘vertical’ and ‘horizontal’ orientations for the various antenna arrays, however such vertical and horizontal arrays could be interchanged with typically no loss of functionality. Likewise the combined arrays 300, 310, 320, 330 shown in FIG. 3(a)-(d) can be rotated to any arbitrary angle without impacting operation in most cases; specifically a rotation of any of the combined arrays 300, 310, 320, 330 by a multiple of 90 degrees could be undertaken without loss of functionality in many applications. Furthermore, it is possible to rotate the individual antenna arrays, for example antenna array #1 discussed in relation to FIG. 3(a) or antenna array #12 discussed in relation to FIG. 3(b) or any other array discussed in relation to any of FIG. 3(a)-(d), by an arbitrary angle with potentially only a minor loss of functionality. The ideal angle between any two notionally orthogonal arrays shown in any of FIG. 3(a)-(d) is 90 degrees and the larger the deviation from this figure, either increasing or decreasing, typically the poorer will be the geolocation performance until a deviation of +/−90 degrees has been reached (i.e. the angle between two arrays reaches zero degrees or 180 degrees) when a very poor level of spatial location or geolocation accuracy of a UE is likely to result. Any array which is capable of producing a measurable beam intersection between two beams generated by two physically-separated antenna arrays, served by different MIMO channels from the same access point will fulfil the basic requirements necessary for the operation of the spatial location or geolocation system which will be described in more detail below.

It should be noted that an antenna lobe (whether a main lobe or a side lobe) formed when receiving a signal from a UE may be referred to as a virtual antenna lobe since the beamformer processing is operating as a spatial filter when receiving signals rather than processing RF signals to be radiated which subsequently form beams (including antenna lobes), as is the case for signals flowing in a transmit direction.

FIG. 3(c) shows a combined antenna array 320 which consists of three separate antenna arrays, with the first formed from antenna elements 321a, 321b, 321c, 321d, the second formed from antenna elements 322a, 322b, 322c, 322d and the third formed from antenna elements 323a, 323b, 323c, 323d. In a similar manner to that discussed in relation to FIG. 3(b), an antenna array formed from antenna elements 322a, 322b, 322c, 322d may be a dual-polarisation array similar to that of an array formed from antenna elements 312a, 312b, 312c, 312d shown in FIG. 3(b). Likewise an antenna array formed from antenna elements 321a, 321b, 321c, 321d may be a single-polarisation array similar to that of an array formed from antenna elements 301a, 301b, 301c, 301d shown in FIG. 3(a) and an antenna array formed from antenna elements 323a, 323b, 323c, 323d may be a single-polarisation array similar to that of an array formed from antenna elements 301a, 301b, 301c, 301d shown in FIG. 3(a). The operation of these arrays and the beam-patterns formed are similar to the corresponding array operation and beam patterns discussed in relation to the corresponding diagrams discussed above. Furthermore, whilst the above discussion was based around dual-polar operation of an antenna array formed from antenna elements 322a, 322b, 322c, 322d, it is equally possible that an antenna array formed from antenna elements 321a, 321b, 321c, 321d could be dual-polarisation, with the remaining two arrays shown in FIG. 3(c) being single polarisation and likewise, it is also possible that an antenna array formed from antenna elements 323a, 323b, 323c, 323d could be dual-polarisation, with the remaining two arrays shown in FIG. 3(c) being single polarisation

FIG. 3(d) is, in essence, a modified version of FIG. 3(b), with antenna elements 331a, 331b, 331c and 331d corresponding to antenna elements 311a, 311b, 311c and 311d respectively and antenna elements 332a, 332b, 332c and 332d corresponding to antenna elements 312a, 312b, 312c and 312d respectively. It could simply be viewed as a version of FIG. 3(b) in which antenna elements 312a, 312b, 312c and 312d have been moved to the right, such that they now form a rotated ‘L’ or corner shape in conjunction with antenna elements 311a, 311b, 311c and 311d (which have been renumbered as 331a, 331b, 331c and 331d in FIG. 3(d)). The operation of the configuration shown in FIG. 3(d) is therefore similar to that of FIG. 3(b) in relation to all of the MIMO variants discussed above in relation to that figure, including 2×2 MIMO with single-polarisation antenna elements, 3×3 MIMO utilising a combination of a single polarisation antenna array and a dual-polarisation antenna array and 4×4 MIMO utilising two dual-polarisation antenna arrays.

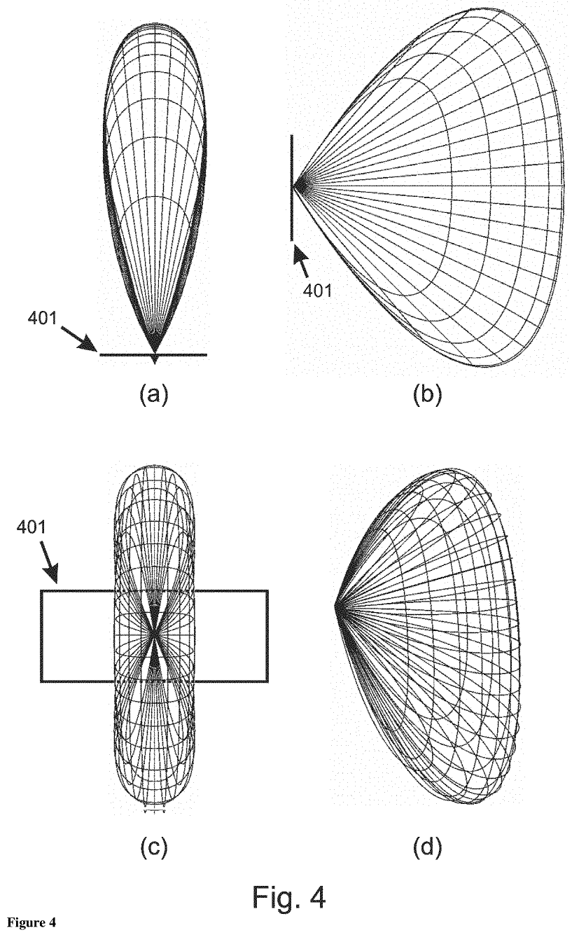

FIG. 4 shows a range of views of an idealised example of an antenna radiation pattern of the form discussed above in relation to FIG. 3: a pattern which is broader in one plane than it is in an orthogonal plane.

FIG. 4(a) shows a wireframe representation of a top view of an idealised approximation of an antenna radiation pattern of a form which could emanate from a horizontally-oriented linear multi-element antenna array, such as that formed from antenna elements 301a, 301b, 301c and 301d in FIG. 3(a). The view shown in FIG. 4(a) is equivalent to looking from a vantage point above the plane 401 of antenna array 300 shown in FIG. 3(a) or, in other words, the plane 401 of antenna array 300 could appear as a horizontal line, running from left to right across the page, as shown, below the radiation pattern shown in FIG. 4(a). The view shown in this figure and, indeed, all of the parts of FIG. 4 is idealised in that it shows a perfectly-symmetrical main lobe and no side-lobes. Whilst this is clearly not representative of a typical antenna radiation pattern, it serves to highlight a fundamental shape of a main lobe of an antenna radiation pattern and this will be used as an example, below, to illustrate the principles of a spatial location technique which may be realised with an access point and antenna structure of the form described herein. The implications of the inclusion of side-lobes within an antenna radiation pattern, and beneficial uses to which side-lobes, in conjunction with one or more main lobes may be put, are also discussed below.

FIG. 4(b) shows a wireframe representation of the side view of an idealised approximation of an antenna radiation pattern of a form which could emanate from a horizontally-oriented linear multi-element antenna array, such as that formed from antenna elements 301a, 301b, 301c and 301d in FIG. 3(a). The view shown in FIG. 4(b) is equivalent to looking from a vantage point to the left or right of a plane 401 of antenna array 300 shown in FIG. 3(a) or, in other words, a plane 401 of antenna array 300 could appear as a vertical line, running from top to bottom down the page, as shown, to the left of the radiation pattern illustrated in FIG. 4(b).

FIG. 4(c) shows a wireframe representation of a front (boresight) view of an idealised approximation of an antenna radiation pattern of a form which could emanate from a horizontally-oriented linear multi-element antenna array such as that formed from antenna elements 301a, 301b, 301c and 301d in FIG. 3(a). The view shown in FIG. 4(c) is equivalent to looking from a vantage point in front of a plane 401 of antenna array 300 shown in FIG. 3(a). It is clear from this view, in particular, that the shape of the beam, which consists purely of a main-lobe in this idealised example, is much larger in a vertical direction that it is in a horizontal direction. As a non-limiting example, the 3 dB beamwidth of the main lobe shown in FIG. 4 could be approximately 90 degrees in an elevation plane and perhaps 10-30 degrees in an azimuth plane.

FIG. 4(d) shows a wireframe representation three-dimensional view of an approximation of an idealised antenna radiation pattern of a form which would emanate from a horizontally-oriented linear multi-element antenna array; the viewpoint is taken from the rear and to the right-hand side of the antenna array, for example an array which could be formed from antenna elements 301a, 301b, 301c and 301d in FIG. 3(a).

In one embodiment of a spatial location or geolocation system, independently formed and steerable beams emanating from an antenna array which is operably-coupled to an access point may be steered to enable communication with a UE and an intersection of two or more beams emanating from an antenna array which is operably-coupled to an access point, which may be the same access point, may be used wholly or in part to approximately spatially-locate a UE the signals emanating from which can be received by an access point.

In a second embodiment of a spatial location or geolocation system, independently formed and steered beams emanating from an access point may be steered to enable or minimise communication with a UE and an intersection of two or more regions of an antenna radiation pattern within which poor communications between a UE and an access point result, where two or more regions of an antenna radiation pattern emanate from an access point, which may be the same access point in both cases, may be used wholly or in part to approximately spatially-locate a UE which is in communication with an access point. Regions of an antenna radiation pattern within which poor communications between a UE and an access point may occur and as discussed above are sometimes referred to as ‘nulls’ in a radiation pattern.

In a third embodiment of a spatial location or geolocation system, independently formed and steered beams emanating from an access point may be steered and signal strength measurements may be made and stored of signals emanating from a UE during a steering or beam sweeping process to form a stored measured radiation pattern, with some or all of those stored signal strength measurements forming the stored radiation pattern being compared or correlated with one or more predetermined reference antenna radiation patterns in order to determine a steering angle or bearing at which a measured and a predetermined radiation pattern are most similar. This steering angle may then be reported as a bearing of a UE relative to a datum, such as a boresight direction of an antenna array forming part of a steerable antenna system or a plane of an antenna array forming part of a steerable antenna system.

In a fourth embodiment of a spatial location or geolocation system, independently formed and steered beams emanating from an access point may be steered and signal strength measurements may be made by a UE and stored of signals emanating from an access point and reported back to an access point by a UE during a steering or beam sweeping process to form a stored measured radiation pattern, with some or all of those stored signal strength measurements forming the stored radiation pattern being compared or correlated with one or more predetermined reference antenna radiation patterns in order to determine a steering angle or bearing at which a measured and a predetermined radiation pattern are most similar. This steering angle may then be reported as a bearing of a UE relative to a datum, such as a boresight direction of an antenna array forming part of a steerable antenna system or a plane of an antenna array forming part of a steerable antenna system.

In still further variants of the first and second embodiments discussed above, signals to be measured could emanate from an access point which contains one or more steerable antennas with signal strength measurements being taken by a UE to be located, with that UE then reporting some or all of those signal strength measurements back to an access point. A peak or a null or any other identifiable beam pattern characteristic could then be identified by an access point within the measured data reported to it by a UE.

In both of the above embodiments, a UE need not be directly or indirectly associated with the access point or any access point, so long as any signals obeying a suitable protocol and occurring in an appropriate frequency range common to both UE and access point, are received by an access point from a UE. Alternatively signals obeying a suitable protocol and occurring in an appropriate frequency range common to both a UE and an access point may be transmitted by an access point and received by a UE, with a UE subsequently sending an acknowledgement back to an access point to indicate that reception of a signal or signals transmitted by an access point has been partially or wholly successfully achieved by a UE. Furthermore a UE may report back to an access point a measure of received signal strength, received signal quality or data rate. A UE is referred to as being associated with an access point where that UE is primarily or exclusively exchanging data with that access point and little or no data is being exchanged with other nearby access points, despite these other access points being within range of transmitter, receiver and antenna circuits of a UE.

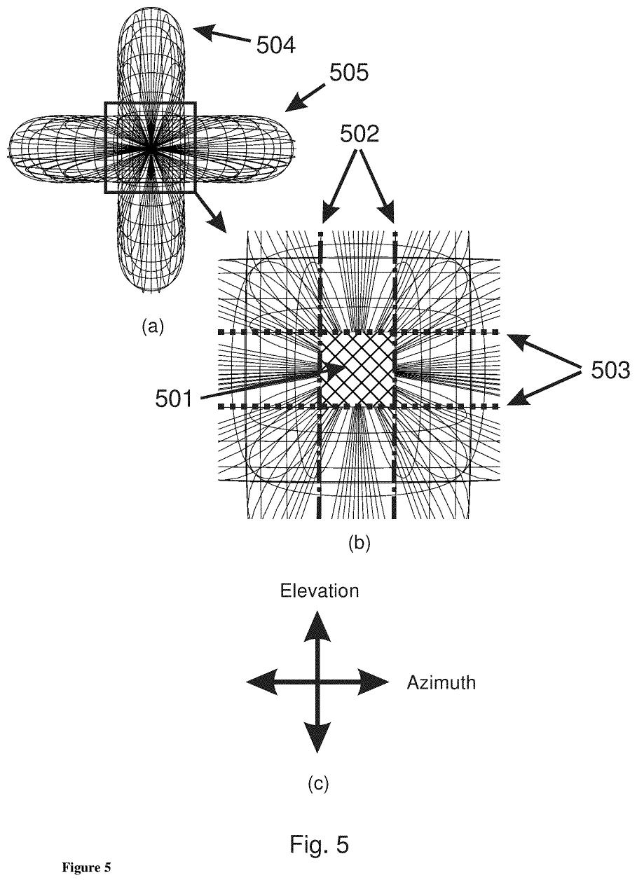

Taking the first embodiment of a spatial location system discussed above, FIG. 5(a) shows an example wireframe representation of a rear (boresight) view, looking away from an antenna array or arrays in a direction of propagation of electromagnetic waves radiating from the array or arrays, detailing an approximation of two intersecting antenna radiation patterns of a form which could emanate from a horizontally-oriented linear multi-element antenna array and a vertically-oriented linear multi-element antenna array, for example of the form shown in FIG. 3(b) or FIG. 3(d). Note that FIG. 5(a) is intended to show a far-field view of an antenna radiation pattern such that the spatial separation of a horizontally-oriented linear multi-element antenna array and a vertically-oriented linear multi-element antenna array appears negligible and the resulting beam patterns appear to be emanating from the same point.

FIG. 5(b) shows a detail view of an intersection of the wireframe representations of the radiation patterns illustrated in FIG. 5(a), highlighting an approximately rectilinear area of intersection 501, shown by means of cross-hatched shading, and lines of constant relative antenna gain 502 and 503 which delineate this area of intersection. Lines of constant relative antenna gain 502 join together two separate loci of points at which the antenna array gain of a vertically-oriented antenna array (not shown), which is capable of generating elevation radiation pattern 504, are X dB below its peak antenna array gain at a given elevation angle from the boresight position of its main lobe, at the current azimuth bearing to which the antenna's main lobe is steered. Likewise, lines of constant relative antenna gain 503 join together two separate loci of points at which the antenna array gain of a horizontally-oriented antenna array (not shown), which is capable of generating azimuth radiation pattern 505, is Y dB below its peak antenna array gain at a given azimuth angle from the boresight position of its main lobe, at the current elevation altitude to which the antenna's main lobe is steered. In a typical embodiment, X may be equal to Y, although this need not be the case and should not be taken as a limiting example.

Take, for example, a horizontally-oriented first antenna array which is steered to a bearing of 10 degrees off boresight in azimuth (i.e. a plane in which its main-lobe is relatively narrow) and which has a main lobe with a peak gain of +10 dBi at that beam position and a vertically-oriented (i.e. orthogonal to the first antenna array) second antenna array which is steered to a bearing of 15 degrees off boresight, in elevation (i.e. a plane in which its main-lobe is relatively narrow) and which has a main lobe with a peak gain of +8 dBi at that beam position. With X and Y both set equal to say 1 dB for this example, a locus of points 502 would connect all points with a main-lobe gain of +9 dBi for the horizontally-oriented first antenna and a locus of points 503 would connect all points with a main lobe gain of +7 dBi for the vertically oriented second antenna, assuming that the approximately rectangular area of intersection 501 is sufficiently small that the variation in gain across this region, in the direction in which the main lobe is widest in each case, is negligible. This is a reasonable assumption for a beam shape, such as those discussed above, which is much wider in one plane than it is in an orthogonal plane.

Lines of constant relative antenna gain 502 and 503 may represent, respectively, the resolution to which received signal strength can be measured by a receiver system connected to the antenna elements (not shown) which generate elevation 504 and azimuth 505 radiation patterns. In this case, approximately rectangular area of intersection 501 represents an area of uncertainty anywhere within which a UE could be located. In such a case, the centre of approximately rectangular area of intersection 501 could be computed and this could be assumed to be a location of the UE from which the signals emanate. This approach could have the benefit of minimising the average error resulting from reporting, separately or together, a spatial location co-ordinate set for of a large number of UEs for which the same received signal strength characteristics are obtained from a receiver system or systems connected to the antenna elements (not shown) which generate elevation 504 and azimuth 505 radiation patterns similar to those shown in FIG. 5(a).

The above example assumed that a UE radiated a signal or signals which were then received by one or more steerable antenna arrays, which were swept in order to determine a region or regions of maximum received signal strength. It is equally possible for a UE to receive signals radiated by an access point equipped with one or more steerable antenna arrays, which were swept in order to permit a UE to measure a variation in received signal strength and report received signal strength readings back to the access point, thereby enabling the access point to identify a region or regions within which the UE experienced a maximum level of received signal strength.

Alternatively, lines of constant relative antenna gain 502 and 503 may represent worst-case error bounds for signal strength measurements made by a receiver system or systems connected to the antenna elements (not shown) which generate the elevation 504 and azimuth 505 radiation patterns shown in FIG. 5(a). Such error bounds may be determined by the amount of noise present on the signal or signals received or could be determined by the dynamic characteristics of the environment in which the UEs are located, for example if the UEs are handheld devices and their users are moving around in a congested environment such as a shopping mall or a busy railway station.

In a still further alternative possibility, lines of constant relative antenna gain 502 and 503 could represent worst-case data rate or signal quality bounds, such that a data rate or signal quality level of greater than a given threshold is achieved but a still greater data rate or signal quality level is unable to be achieved at that location. This option arises from the fact that, for example, Wi-Fi systems will typically ‘negotiate’ a data rate between one transceiver node and a second, distant, transceiver node, in ‘steps’ rather than as a continuous variation in data rate, based upon the signal strength received by each node and the interference level received at each node; note that the data rates need not be the same in both directions, since the levels of interference suffered by each node may be different due to their differing local radio environments. For a received signal incident at a particular point within an antenna's beam pattern a given data rate may be negotiated between its attached transceiver and a further transceiver from which the received signal emanated and, despite the antenna being capable of providing a slightly greater level of gain (and hence a slightly greater received signal strength) when using a slightly more optimal beam direction, the improvement in received signal strength at this beam direction may not be sufficient to allow the next higher ‘step’ in data rate to be sustained between the two nodes. Lines of constant relative antenna gain 502 and 503 could therefore alternatively represent separate loci of points at which the highest achievable data rate which can be maintained (however briefly) between the two nodes is achieved, with a yet higher gain beam position not being sufficiently better for the data rate to increase to the next-highest data rate step, for example going from 57.8 Mbits/sec to 65 Mbits/sec in the case of the IEEE 802.11n standard.

FIG. 5(c) indicates the orientations of azimuth and elevation in the above discussion of FIG. 5.

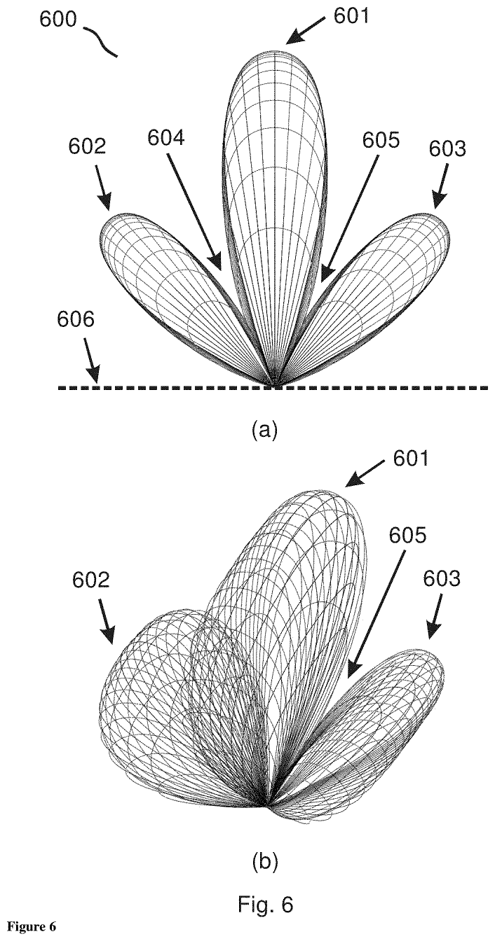

FIG. 6(a) and FIG. 6(b) show two views of a more realistic representation of an antenna beam pattern than did FIG. 4(a)-(c). FIG. 6(a) again shows a wireframe representation 600 of a top view of an approximation of an antenna radiation pattern of the form which would emanate from a horizontally-oriented linear multi-element antenna array, such as that formed from antenna elements 301a, 301b, 301c and 301d in FIG. 3(a); it is thus a more realistic equivalent of FIG. 4(a). The view shown in FIG. 6(a) is equivalent to looking from a vantage point above the plane of the combined antenna array 300 shown in FIG. 3(a) or, in other words, the plane of the combined antenna array 300 would appear as a horizontal line 606 (shown dashed), running from left to right, across the page, below the representation of the radiation pattern 600 shown in FIG. 6(a).

Wireframe representation 600 of a top view of an approximation of an antenna radiation pattern consists of main lobe 601, a left-hand side-lobe 602 and a right-hand side-lobe 603, together with a left-hand null 604 and a right-hand null 605. Left-hand null 604 and right-hand null 605 represent areas of the antenna's radiation pattern where the antenna possesses, locally, very low levels of antenna gain relative to those present at main lobe 601 or at side-lobes 602 and 603, such that the antenna radiates relatively low levels of electromagnetic radiation in those directions and will receive even strong signals incident from those directions relatively weakly, resulting in low RF signal levels being sent from the antenna's connector to any attached receiver circuits.

FIG. 6(b) shows a wireframe representation three-dimensional view of an approximation of an antenna radiation pattern of the form which would emanate from a horizontally-oriented linear multi-element antenna array with a two-dimensional, top-view, radiation pattern similar to that shown in FIG. 6(a); the viewpoint is taken from a location looking from below and down upon the antenna array itself as if floating in space above the plane of the antenna array. The main lobe 601, side-lobes 602, 603 and nulls (e.g. 605) can clearly be seen in this view.

It is possible to steer or sweep, electronically, the example beam patterns shown in FIG. 6(a) and FIG. 6(b) in order to find a peak in signal strength, which could be the highest peak, or main lobe, a lower peak, or sidelobe, or one or other or both of the nulls. Sweeping a beam in this way, to locate a remote transceiver station or UE by means of locating one or more peaks in received signal strength, one or more nulls in received signal strength or a particular, known, pattern of peaks and nulls which may be used to identify whereabouts within the antenna's radiation pattern characteristic a UE is located, from measurements taken by either of the UE or the access point, is a key aspect of the present invention.

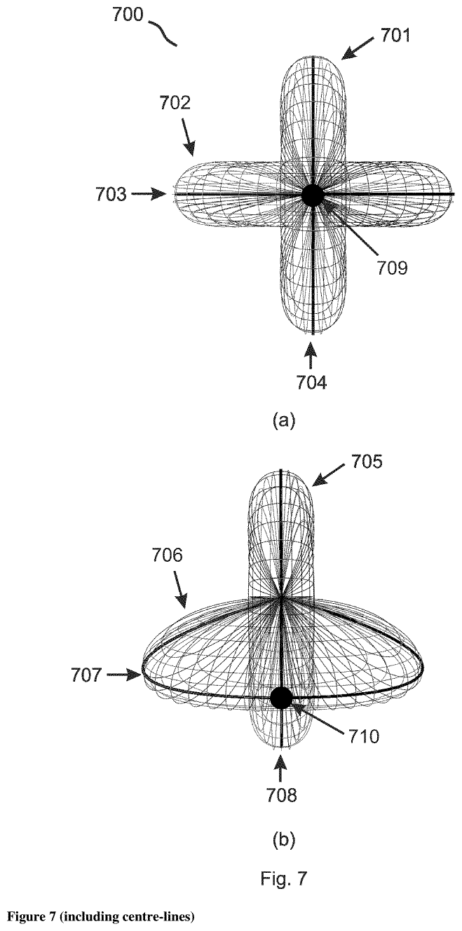

FIG. 7(a) shows a similar view to that of FIG. 5(a) in that it shows a wireframe representation 700 of a rear (boresight) view, looking away from an antenna array or arrays in a direction of propagation of the electromagnetic waves radiating from the antenna array or arrays, detailing an approximation of two intersecting antenna radiation patterns of a form which could emanate from a horizontally-oriented linear multi-element antenna array and a vertically-oriented linear multi-element antenna array, for example of the form shown in FIG. 3(b) or FIG. 3(d). In the case of FIG. 7(a), however, the approximately rectangular area of intersection 501 highlighted in FIG. 5(b) has been replaced by an intersection of two separate loci of points 703, 704, representing a peak gain of an antenna array, in azimuth and elevation, as will now be described.

Locus 703 shows a line joining points representing roughly a peak value of gain, whether of a main-lobe or a side-lobe, of a horizontally-oriented antenna array (not shown), which is capable of generating azimuth radiation pattern 702 at a given azimuth angle from a boresight position of its main lobe or a side-lobe, at the current elevation altitude to which the antenna's main lobe or a side-lobe is steered. The antenna array could, for example, be formed using antenna elements 301a, 301b, 301c and 301d in FIG. 3(a).

Locus 704 shows a line joining points representing roughly a peak value of gain, whether of a main-lobe or a side-lobe, of a vertically-oriented antenna array (not shown), which is capable of generating elevation radiation pattern 701 at a given elevation angle from the boresight position of its main lobe or a side-lobe, at the current azimuth bearing to which the antenna's main lobe or a side-lobe is steered. The antenna array could, for example, be formed using antenna elements 302a, 302b, 302c and 302d in FIG. 3(a).

If elevation radiation pattern 701 is steered in azimuth, i.e. left-to-right or right-to-left as viewed in FIG. 7(a), and azimuth radiation pattern 702 is steered in elevation, i.e. top-to-bottom or bottom-to-top as viewed in FIG. 7, independently, such that the peak gain of each is directed at a UE, then intersection 709 of locus 703 and locus 704, representing the peak gains in azimuth and elevation respectively, indicates an azimuth and elevation bearing respectively for the UE with respect to a datum based upon a feature of the antenna arrays, for example their un-steered boresight direction or a plane of one or both arrays. In this way, a UE may be located in two dimensions in space by reading or recording the bearings to which radiation patterns 701 and 702 are steered.

FIG. 7(b) shows a similar situation to that of FIG. 7(a), however in this instance azimuth radiation pattern 706 has been steered downward in elevation, such that an intersection 710 between locus 707 (analogous to locus 703 in FIG. 7(a)) and locus 708 (analogous to locus 704 in FIG. 7(a)) is now lower in elevation within the coverage area of the antenna arrays. Elevation radiation pattern 705 has not been moved in this example and resides at the same bearing and altitude as elevation radiation pattern 701 of FIG. 7(a). Even in this instance, there is still an intersection of locus 707 and locus 708, which can indicate the location of a UE as described above in relation to locus 703 and locus 704, despite the absolute gain of an antenna array generating elevation radiation pattern 705 at this elevation altitude being likely to be lower than the level it would have exhibited with the beam locations shown in FIG. 7(a).

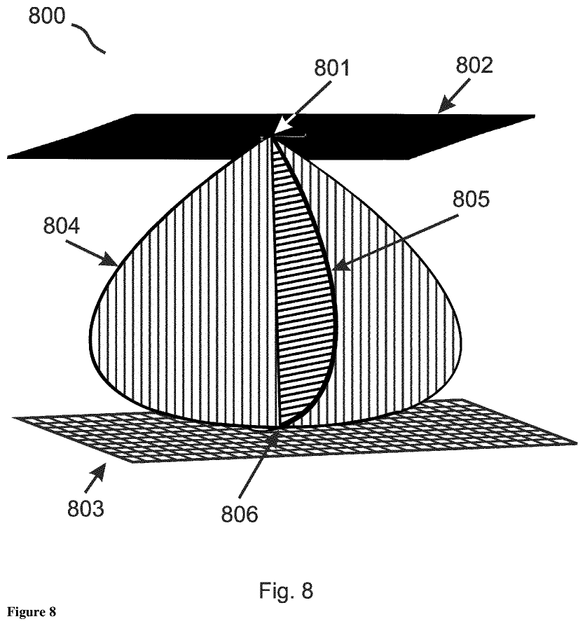

FIG. 8 illustrates an example of the operation of a beam-crossing technique for spatial location in two dimensions, based upon, for example, a ceiling-mounted antenna system. An antenna system (not shown) of the form described herein or of another form capable of generating independently-steerable beams operating in at least two planes and with differing beamwidths in each plane, is placed at location 801, for example mounted on a ceiling 802 of a room or building. The antenna system may generate two radiation patterns which each have a beam shape which is much wider in one plane than it is in an orthogonal plane, between, say, the −3 dB points of the gain of the antenna arrays relative to their peak gain values. A locus of points, termed a peak-gain locus, may be formed joining together points located in the wider plane of the beam pattern at which the gains achieved in the narrower plane of the beam pattern are at their peak values, at any given offset angle from boresight in the plane of the wider-beam. Note that the absolute gain level of these peak values will differ as the offset angle changes; the highest peak value will typically be achieved on boresight, with progressively lower values typically being achieved as the angular separation between the boresight angular location and the angular location under consideration, increases, up to the point where a side-lobe is reached.

A peak-gain locus for one example antenna main-lobe 804 and a second peak-gain locus for a second example antenna main-lobe 805 are shown in FIG. 8. These two loci are illustrated in this figure based upon beams pointing almost directly downwards from ceiling 802, however it should be appreciated, from the preceding discussions, that these beams may be steered to any angle or angles in a plane which lies approximately perpendicular to a virtual planar surface defined by (or substantially enclosed by) their peak gain loci 804, 805, and which are within a steering capability of a beam-steering system and an antenna system. Loci 804 and 805 can be steered or ‘swept’ across area 803, which could be a floor area, for example, in order to locate signals from one or more UEs. As a peak gain locus sweeps across a UE, in response to beam-steering control from a beam-steering control system (e.g. control system 202 of FIG. 2) a signal strength measured by a receiver system attached to a control system and the beam-steered antenna array or a signal strength measured by a receiver system within a UE to be located and which is reported back to a receiver system attached to a control system and the beam-steered antenna array, will typically increase and then, once a location of peak gain of the antenna has been passed, will typically decrease again. It is possible that either or both of the increasing or decreasing signal strength values just discussed will not be monotonic. This increase in measured signal strength followed by a decrease of measured signal strength, as the beam sweeps toward and then past a UE, may be used as input data to a control algorithm which may be used to steer an antenna beam, via a beam-steering control system (e.g. control system 202 of FIG. 2) and a beamformer (e.g. 204 of FIG. 2) to point a peak of the antenna's beam pattern (or gain characteristic) at a UE. Alternatively, the beam-steering angle at which a peak in received signal strength was recorded may simply be noted or reported, since this will typically represent an angle, in that particular plane, at which a UE is located. It may be necessary to repeat either or both of the above processes a number of times, in order to average the results or statistically process the results in some other way, in order to ameliorate the effects of noise, interference, or short-term changes in the environment, such as the movement of people or objects, upon the measured receive signal strength values.

The above process of sweeping a beam, as characterised by its peak gain locus, in a plane approximately perpendicular to a virtual surface defined by its said peak gain locus, may be carried out independently for two or more beams wherein at least two of the two or more beams are swept in non-identical (defined as non-parallel) planes. In the case illustrated in FIG. 8, locus 804 defines a virtual surface, illustrated by vertical shading, and locus 805 defines a second virtual surface illustrated by horizontal shading (and which is only partially visible; it extends into the page to form a similarly-shaped virtual surface to that defined by locus 804). If the two example beams shown in FIG. 8, are located at steering angles at which a UE, independently for each beam, yielded a peak value of received signal strength, then a point 806 at which the virtual planes defined by loci 804 and 805 cross and intersect a floor 803 (and assuming that a UE under consideration is located on or above that floor) is an approximate location of the UE, in two dimensions within the plane defined by floor 803.

Whilst the above discussion has concentrated upon loci defining the peak gain of a main beam, in a further embodiment it could equally apply to loci defining peak gains for one or more side-lobes of an antenna array radiation pattern. This may be advantageous in extending a range of angles over which a given spatial location system can operate, without having to alter the design of the antenna or beam-steering system, since side-lobes typically extend to much greater angles away from boresight than does a main lobe.

In a further, related, embodiment, it is possible to define loci which are based upon the or a minimum gain position or positions for an antenna when swept to search for a UE, for example gain or attenuation values which define and hence can locate nulls such as nulls 604 or 605 shown in FIG. 6. In this case, the beam sweeping processes outlined above could search for, and record or otherwise highlight, beam angles at which a minimum of signal strength was measured at one or more receiving devices operably connected to the antenna array or arrays or reported by a UE back to a receiver and control system connected to the antenna array or arrays. An advantage of this ‘null-searching’ approach is that, as the nulls are typically sharply-defined and are typically more sharply-defined than beam peaks, whether main-lobes or side-lobes, the resulting angles recorded by the spatial location system may be more accurate than those recorded using a beam-peak searching methodology such as the example outlined above.

A yet further embodiment would combine both of the above approaches, searching for both nulls and peaks in an antenna array gain characteristics and recording both or all angles at which nulls and peaks occurred during the sweeping processes, optionally including those related to side-lobes. Given that the location of both peaks and nulls may be approximately determined either from the design of the system, simulations conducted on the designed system or field measurements conducted upon one or more (or all) samples of a manufactured or prototype system, then these known locations (offset angles) at which the various characteristics, whether peaks of nulls or some other characteristic, can be used to measure the beam-steering angles at which a UE or many UEs are located. Note that it is possible to uniquely spatially locate multiple UEs designed to operate with one or more of a wide range of radio systems, since transmissions to the said UEs are typically identified for, or directed at, each UE individually. For example, a given UE may have its own individual time-slot allocated in a time division multiple access system and transmissions to and from that UE will only or predominantly take place during that or those allocated time-slots. Thus it is possible to search for a beam-peak or a null or both for a particular UE during one or more time-slots allocated to that UE. Similarly, it is possible to search for beam-peaks or nulls on frequencies allocated, uniquely for a period, to a given UE or to codes in a CDMA system, allocated to a particular UE or by any other mechanism by which transmissions to or from a UE can be uniquely identified.

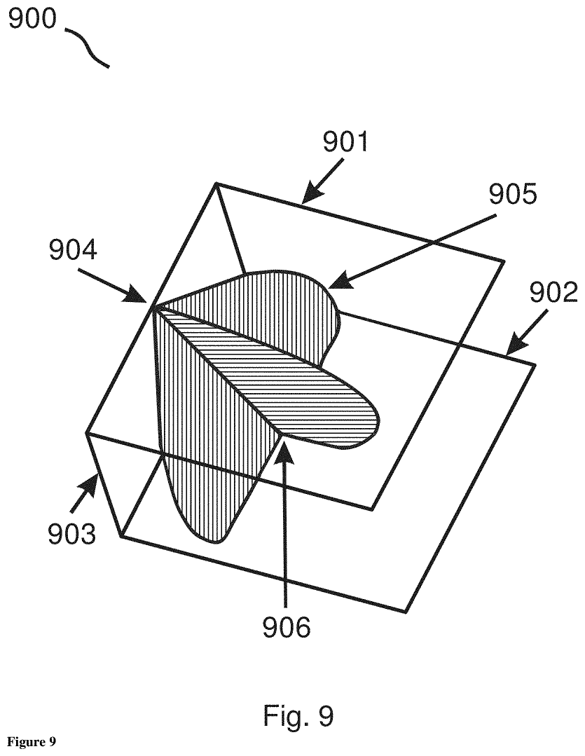

FIG. 9 illustrates a further example 900 of the operation of a beam-crossing technique for spatial location in two dimensions, based upon an antenna system (not shown) or a complete access point (not shown) containing an antenna system placed at a location 904 which is high-up on a wall 903 close to or adjoining a ceiling 901 and subtending an angle to the ceiling 901 which is between −0.1 degrees and −90 degrees, in other words, pointing at least partially in a downward direction toward a floor 902. An antenna system (not shown) of a form described herein or of another form capable of generating independently-steerable beams operating in at least two planes, is placed at location 904, as just described, for example mounted using an angled bracket on a ceiling 901 or a wall 903 of a room or building. The antenna system may generate two radiation patterns which each have a beam shape which is much wider in one plane than it is in an orthogonal plane, between, say, the −3 dB points of the gain of the antenna arrays relative to their peak gain values. A locus of points, termed a peak-gain locus, may be formed as described above in relation to FIG. 8 joining together points located in the wider plane of the beam pattern at which gain levels achieved in the narrower plane of the beam pattern are at their peak values, at any given offset angle from boresight in the plane of the wider-beam.

The operation of the system illustrated in FIG. 9 is similar to that of the system illustrated in FIG. 8 with the beam-patterns shown being illustrated in a similar manner, based upon peak-gain loci. The beam patterns shown in FIG. 9 may be steered or swept using one or more control systems and one or more beamforming systems as discussed in relation to FIG. 8. An intersection 906 of beams or particular parts of beams or a locus of points on beams, based upon, say, a locus of peak gain values of one or more of the beams in a plane in which the beamwidth of the antenna main lobe is at its narrowest, may be used to indicate a likely two-dimensional spatial position of a UE with which the access point to which the antenna array or arrays is connected, is in communication.

The pointing angle at which an access point or antenna array is mounted, in the example deployment scenario illustrated in FIG. 9, is instrumental in determining the coverage which can be achieved from that array or access point and is a partial determinant of spatial location accuracy, particularly for UE which are more distant from the access point or antenna array. For example, consider an antenna array which can be steered in elevation over an angular range of +/−45 degrees from boresight, where boresight is assumed to be perpendicular to the plane of the array in two dimensions, and which has a useful beamwidth, in the plane of its widest beam, of say 90 degrees, where its useful beamwidth can be defined as the angular range over which the beam is able to satisfactorily communicate with a UE (which may well not be the same as its −3 dB beamwidth, for example). If this array is mounted at a position 904 which is adjacent to a wall 903 and a ceiling 901 and angled pointing downward at 45 degrees to the horizontal (e.g. the ceiling), then the array will be capable of satisfactorily covering most or all points between wall 903 and ceiling 901 within an angular range of +/−45 degrees to the wall in a horizontal plane. If the array is mounted at a greater angle to the horizontal of say 50 or 60 degrees, then the range of coverage of the antenna array or access point is likely to be reduced, as the beam is pointed more toward the floor 902, however, the location accuracy may increase in this scenario, since each beam-steering angular digital ‘step’ will correspond to a smaller distance when considering more distant UEs.

It will be obvious to those skilled in the art that various other mounting locations for an antenna array or arrays or an access point containing an antenna array or arrays are possible whilst not detracting from the principles of operation of the invention described herein. For example, such a system could be mounted at any point and positioned at any angle on a wall, on a ceiling, in a corner, on a sloping ceiling such as are commonly found in stairwells, on a gantry, beam or other support structure or on, in, above or below any other suitable mounting location which is appropriate to permit the radiation of signals over a desired coverage area, based upon the available steering range of the antenna system.

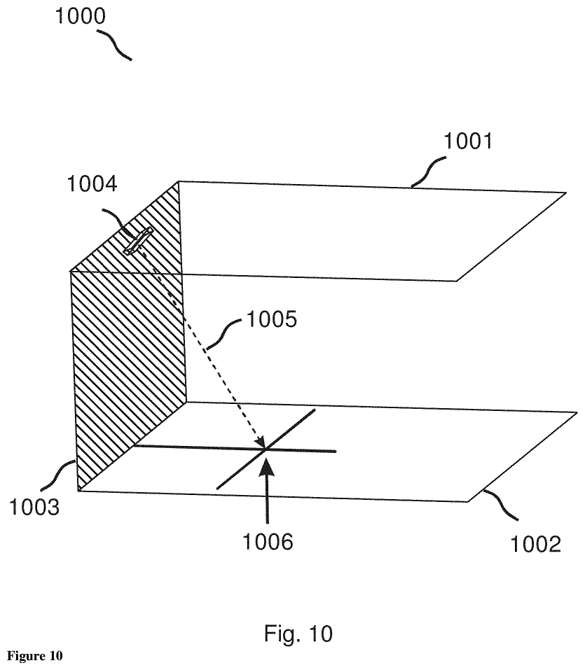

FIG. 10 illustrates a similar example scenario to FIG. 9, however in this case, the shaded surfaces and locus lines have been removed from the diagram, for clarity, and only the beam intersections are illustrated. Access point 1004 is mounted at an angle to the ceiling 1001 and on or close to a wall 1003. A locus of an intersection 1005 between at least two beams intersects a floor 1002 at intersection 1006. Assuming that the at least two beams are directed at a UE at known positions in their beam characteristics (e.g. at peaks of their main lobes), then a spatial location of the UE can be derived as being at, or close to, intersection 1006.

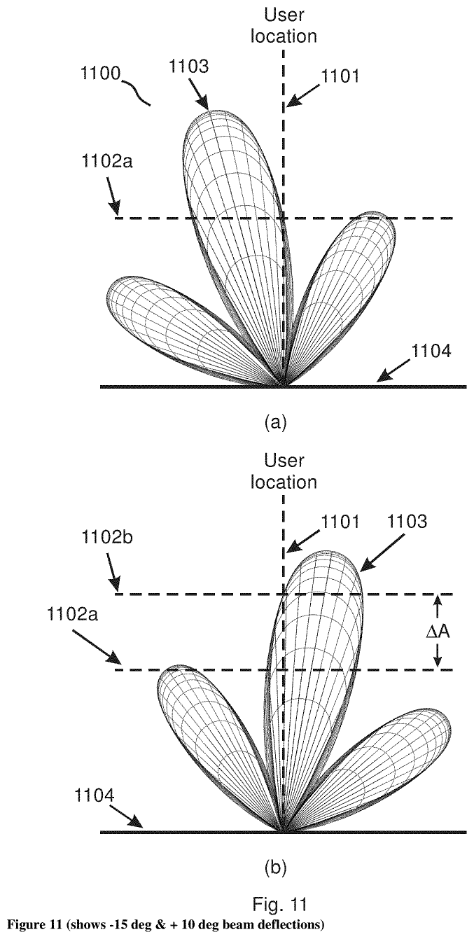

FIG. 11 illustrates one example mechanism by which a UE may be located by means of switching or sweeping an antenna beam 1103 between two or more positions (with only two positions being illustrated in FIG. 11(a) and FIG. 11(b)). Consider, first, FIG. 11(a). A User in possession of a UE is located at an angle to the plane of the antenna array 1104 shown by means of a dashed line 1101; in this example the UE can be seen to be located at an angle of approximately 90 degrees to the plane of the antenna array (and approximately on boresight for the antenna array as shown). In FIG. 11(a), an antenna beam 1103 can be seen to have been switched or steered to the left of boresight, in this case by approximately 15 degrees, although any other steering angle could be chosen. At this steering angle, a received signal level, illustrated by dashed line 1102a can be measured at a receiver connected to the antenna array.

In FIG. 11(b), antenna beam 1103 can be seen to have been steered to the right of boresight, in this case by approximately 10 degrees, although here, again, any steering angle could have been chosen. At this new steering angle, a new received signal level, illustrated by dashed line 1102b can be measured at a receiver connected to the antenna array. A difference in measured received signal strength amplitudes, ΔA, between the two received signal strength measurements taken at each of the two beam positions, provides an indication of the beam-steering error of the antenna's main lobe with respect to the location of the UE. If the main lobe of the antenna (for example antenna beam 1103) is assumed to be symmetrical about its point of peak or maximum gain, then a non-zero value for ΔA indicates that the beam has been switched between two positions which are not equally located on either side of the angular location at which the UE is positioned. In the case shown in FIG. 11, the beam position illustrated in FIG. 11(b) is closer to the angular position of the UE and this will be evident by the fact that the signal strength amplitude 1102b measured at the illustrated beam angle in FIG. 11(b) will typically be higher than a corresponding signal strength amplitude 1102a measured at the illustrated beam angle in FIG. 11(a). A new beam position can now be tried, for example to the left of boresight, with the difference between the new position and the original left-of-boresight position illustrated in FIG. 11(a) typically being determined, at least partially, by the size of the value of ΔA; a large value of ΔA would typically indicate that there is a gross error in the original left-of-boresight beam position and hence a large change in position is needed, whilst a small value of ΔA would typically indicate that there is a smaller error in the original left-of-boresight beam position and hence a small change in position is needed. In this way, the value of ΔA can be progressively reduced by attempting and refining steering angles for antenna beam 1103. Once ΔA has been reduced to an acceptable level, the two beam positions which result in this small value, with one being to the left of boresight and one being to the right of boresight, provide two angular measurements (steering angles for antenna beam 1103) which are approximately equidistant, in an angular sense, from the angular location 1101 of a UE. The angular location of the UE can then be calculated by taking, for example, the lower beam angle, say to the left of boresight and adding to it half of the difference between the lower beam angle and the higher beam angle.

Taking the values given above of a first steering angle of −15 degrees relative to boresight (where boresight is defined as being notionally at an angle of 90 degrees to the plane of the antenna array) or 75 degrees relative to the plane of the antenna array and a second steering angle of +10 degrees relative to boresight (i.e. to the right of boresight) or 100 degrees relative to the plane of the antenna array, the first steering angle would be reduced from −15 to −10 degrees (i.e. from 75 degrees to 80 degrees) in one or more steps, to reduce ΔA to approximately zero and thereby form a third steering angle (which would equal −10 degrees relative to boresight or 80 degrees relative to the plane of the antenna array). This would result in a difference between the two steering angles of 100−80=20 degrees, with half of this value being 10 degrees. Adding this to the lower beam angle (80 degrees) gives 80+10=90 degrees as the angular location of the UE, which corresponds to the situation illustrated in FIG. 11.

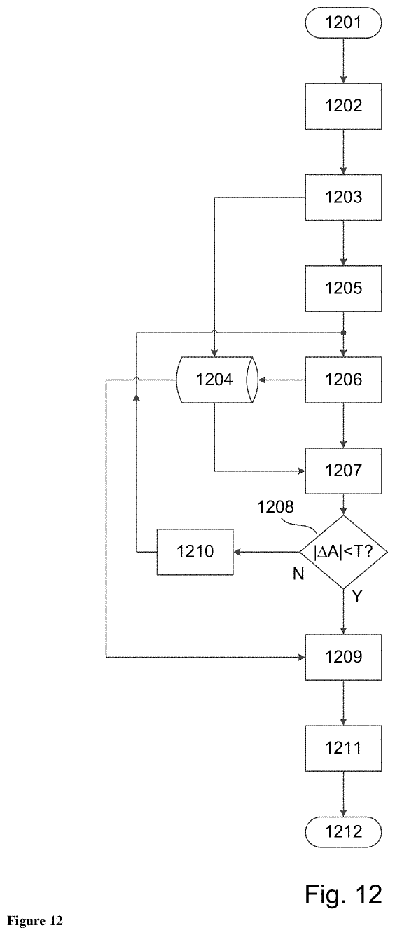

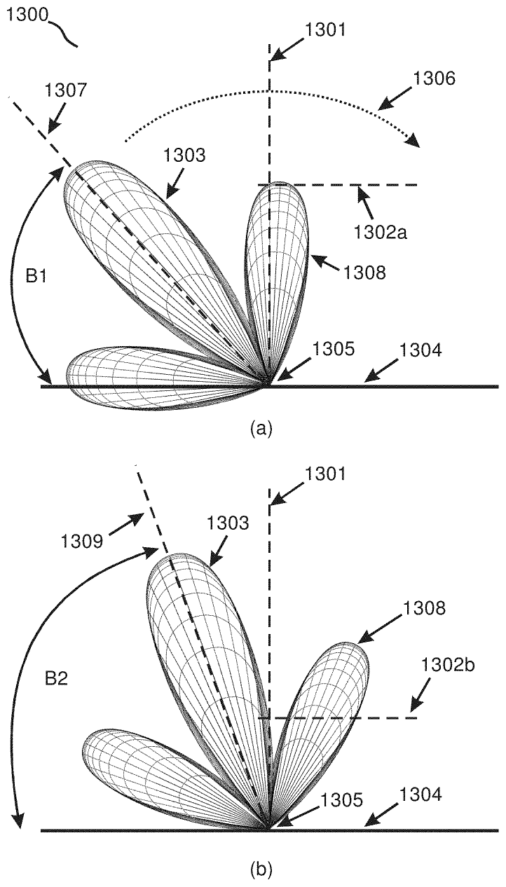

FIG. 12 shows a flow-chart representation of the UE angular location method described above. The method begins at step 1201 and at step 1202 an estimated initial beam angle is chosen which is somewhat to one side, say to the left side, of an expected approximate location of the UE and a beam is steered to that angle. At step 1203 a first received signal strength of a signal received from the UE is measured by a receiver connected to the antenna array and both the beam angle at which the measurement takes place and the corresponding received signal strength measurement are stored in store 1204.

At step 1205, a second estimated initial beam angle is chosen which is somewhat to the other side, say to the right side, of an expected approximate location of the UE and a beam is steered to that new angle. At step 1206 a second received signal strength of a signal received from the UE is measured by a receiver connected to the antenna array and both the beam angle at which the measurement takes place and the corresponding received signal strength measurement are again stored in store 1204.

At step 1207 the first and second signal strength values are retrieved from store 1204 and the absolute value of a difference, ΔA, between the signal strength values is calculated, for example by subtracting the first signal strength value from the second signal strength value and calculating the modulus of the result, yielding |ΔA|. At decision step 1208, a difference, |ΔA|, between the signal strength values is compared to a threshold, T, where T is typically a small positive number and may be close to zero.

If the result of the comparison undertaken in step 1208 is that |ΔA| is not less than threshold T, then the method moves to step 1210. If, on the other hand, the result of this comparison is that |ΔA| is less than threshold T, then the method moves to step 1209.

Step 1210 is only undertaken in the event that the difference between the first and second signal strength values, |ΔA|, is not sufficiently small for the method to continue to step 1209. In step 1210, a new value is chosen or calculated for a second estimated beam angle which is chosen to be to the same side, say to the right side, of an expected approximate location of the UE as was the original second estimated initial beam angle and a beam is then steered to the new angle. The method then continues with step 1206 and so on, as discussed above. Note that the amplitude value then measured in step 1206 and the corresponding beam angle value may, in one embodiment, be appended to store 1204 or may, in a second embodiment, over-write the originally stored values retained in store 1204 and which were derived at the original second estimated initial beam angle.

At the point at which the result of the comparison step 1208 is that |ΔA| is less than threshold T, then the method moves to step 1209, as discussed above. At step 1209, the angular difference between the first estimated beam angle value and the second estimated beam angle value (or the latest version of the second estimated beam angle, in the event that a number of iterations are required in order for the comparison undertaken in step 1208 to become true) is calculated and approximately one half of this difference is added to the numerically lower valued beam angle, resulting in an estimated UE angular bearing relative to the plane of the antenna array. The resulting estimated UE angular bearing is then reported in step 1211 and the method ends at step 1212. The method could, of course, be repeated as often as is required to continue to track a UE which is, or may be, in motion within the coverage area of the access point or antenna system.

In a further embodiment, the method could operate with signal strength values reported to the method by a UE rather than values measured by an access point and reported to the method. In this further embodiment, the access point would operate as a signal source and the beam would be switched or swept as described above, with the UE measuring the signal level it received at each step and reporting these signal levels back to the access point which was executing the method.

Consider now a complete spatial location system, consisting of two or more antenna arrays which are together capable of generating at least two non-parallel antenna patterns which are wider in one plane than they are in an orthogonal plane. In one embodiment of a spatial location system according to the present invention, the algorithm described above with reference to FIG. 11 and FIG. 12 or any other suitable algorithm or algorithms may be utilised independently or together to provide an angular location, relative to boresight or any other datum, of one or more UEs in two or more separate planes utilising two or more separate antenna arrays or sub-arrays or two or more polarisations from one or more separate antenna arrays. In this way, at least two angular locations for the UE may be derived, in non-parallel planes and the intersection of these planes at the point or points identified by each algorithm, or each execution of the same or a similar algorithm, may then be used to estimate the location of the UE in at least two dimensions.

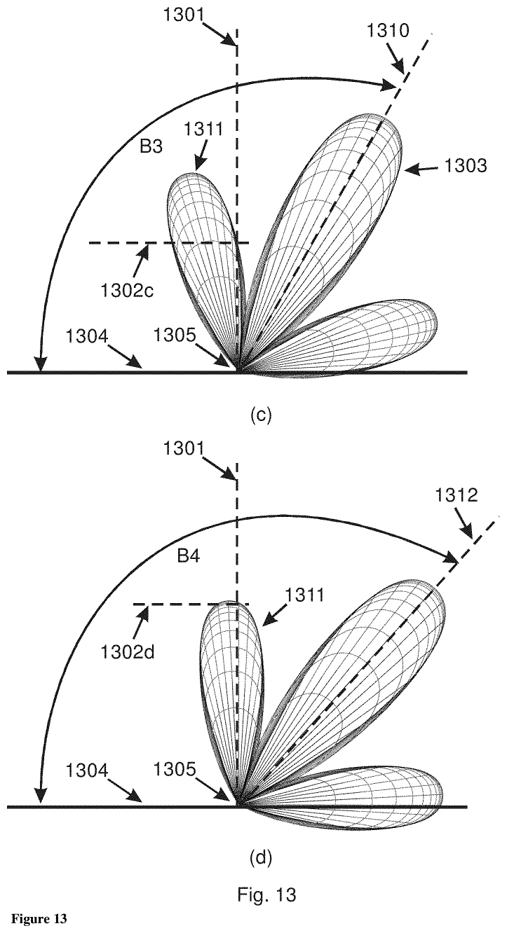

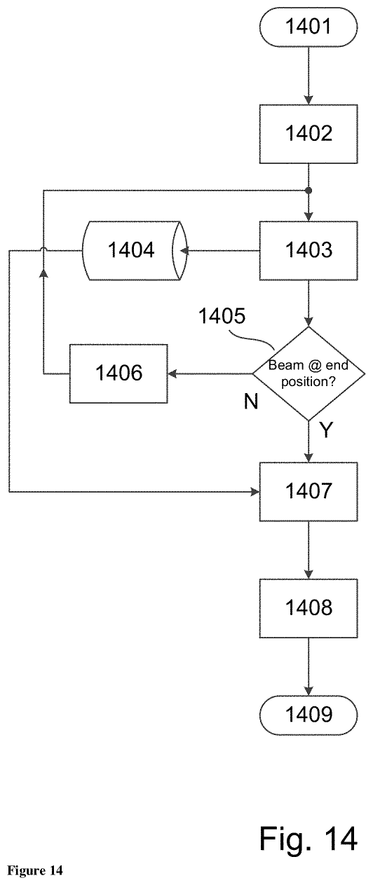

An alternative embodiment of a method for spatially-locating a UE will be described below with reference to FIG. 13 and FIG. 14. In simple terms, an antenna beam or beam pattern which has one or more lobes which are broader in one plane than in an approximately orthogonal plane, such as the form of beam pattern shown in FIG. 6(a) and FIG. 6(b), may be ‘swept’ in the plane of its narrowest lobe or lobes. This can be imagined as the antenna pattern of FIG. 6(a), being swept about a point at which it nominally emanates from a plane of its associated antenna array. FIGS. 13(a), (b), (c) and (d) illustrates four different example ‘snapshots’ of the beam pattern of FIG. 6(a) as it is swept from left to right, covering a bearing angle from B1 degrees through B2 and B3 degrees to B4 degrees from the plane of the antenna array 1304. In this example scenario, B1 and B4 are approximately equal, however any two angles which are both within the capabilities of the antenna array to sweep (in conjunction with an associated beamformer and control system) and which cover the required area within which spatial location is desired, could be chosen.

FIG. 13(a) shows an example antenna beam pattern 1300 with a main-lobe 1303 which has been steered to an initial bearing 1307 which is at an angle B1 to the plane of an antenna array 1304. The approximate centre point about which the antenna array's beam may be steered 1305 is shown close to the centre of the antenna array 1304, however it could be located at any point within or possibly also outside of the array, depending upon the design of the array and the composition of the various signals feeding the elements. The antenna array 1304 is connected to a beamformer (not shown) and a control system (not shown), forming a beam-steering system, as described earlier in this disclosure or any other form of beam control, switching, sweeping or steering system, for the purposes of allowing the antenna array's beam pattern to be swept, electronically, across most or all beam angles commensurate with the resolution or beam-step size of the beam-steering system and which fall within the capability of the design of the antenna array 1304 and its associated beam-steering system.

At initial bearing 1307 for a main lobe of a beam-steered antenna array and considering a bearing 1301 for a UE which is to be located, a signal strength level 1302a could be measured at a receiver attached to the beam-steered antenna array. Note that at initial bearing 1307 the UE would be received using a right-hand side-lobe 1308 resulting in a comparatively high signal strength being recorded at the receiver, considering how far, in angular terms, the UE is away from being received by the main lobe 1303 of the antenna array. The main lobe of the beam-steered antenna array may be swept, electronically (i.e. with little or no physical or mechanical movement of the antenna array or its constituent parts) clockwise in the direction of the dotted-line arrow 1306. This is not, however, a limiting example, and the main lobe of the beam-steered antenna array could equally well begin at a different angle to the plane of the antenna array 1304 and be swept in an anticlockwise direction.

FIG. 13(b) shows an example of an antenna beam pattern part-way through a sweep from initial bearing 1307 to final bearing 1312 (final bearing 1312 is shown in FIG. 13(d) and discussed further below). In FIG. 13(b), a main lobe of the antenna array 1304 has reached first interim bearing 1309 which occurs at an angle B2 to the plane of the antenna array 1304. At this beam position a UE to be located which is placed at a bearing 1301 (as before) would appear close to a minimum (a minimum antenna array gain value) of the antenna beam pattern, in between main lobe 1303 and right-hand side-lobe 1308. Signal strength level 1302b, which in this example would be somewhat lower than signal strength level 1302a discussed above, could be measured at a receiver attached to the beam-steered antenna array.

FIG. 13(c) shows a further example of an antenna beam pattern part-way through a sweep from initial bearing 1307 to final bearing 1312 (final bearing 1312 is shown in FIG. 13(d) and discussed further below). In FIG. 13(c), a main lobe of the antenna array 1304 has reached second interim bearing 1310 which occurs at an angle B3 to the plane of the antenna array 1304. At this beam position a UE to be located which is placed at a bearing 1301 (as before) would appear part-way down left-hand side-lobe 1311 of the antenna beam pattern, in between main lobe 1303 and left-hand side-lobe 1311. Signal strength level 1302c, which in this example would be somewhat higher than signal strength level 1302b but still lower than signal strength level 1302a, could be measured at a receiver attached to the beam-steered antenna array.

FIG. 13(d) shows a still further example of an antenna beam pattern during a sweep from initial bearing 1307 to final bearing 1312. In FIG. 13(d), a main lobe of the antenna array 1304 has reached final bearing 1312 which occurs at an angle B4 to the plane of the antenna array 1304. At this beam position a UE to be located which is placed at a bearing 1301 (as before) would appear close to the top (higher antenna array gain value) of left-hand side-lobe 1311. Signal strength level 1302d, which in this example would be somewhat higher than signal strength level 1302c and potentially similar to signal strength level 1302a discussed above, could be measured at a receiver attached to the beam-steered antenna array.

In the example described above in relation to FIG. 13(a)-(d), four signal strength values 1302a, 1302b, 1302c and 1302d are obtained for the UE, at the four different bearings shown. These values can be seen to vary according to the point within the antenna's beam pattern at which the UE's signal appears; the UE is assumed not to have moved during the sweeping process or to have moved by a negligible amount in relation to the accuracy required of the spatial positioning system and hence this variation is largely or wholly due to the shape of the antenna array's beam characteristics as its beam pattern is ‘swept past’ the quasi-static UE (for example in the direction of arrow 1306). The UE can be considered to be quasi static in most implementations of an electronic beam-sweeping or steering system, since the rate of change of angle of the electronic beam-steering antenna system is typically much faster than the likely rate of change of angle subtended by a moving (e.g. walking) user and associated UE. If a UE is assumed to be quasi-static, the sweeping process and its resultant changes in received signal strength as measured at a receiver connected to a beam-steerable antenna array, can approximately reproduce a radiation pattern (or beam pattern) of a beam-steerable antenna array, in much the same way as would be obtained from an antenna measurement range or system which is capable of two-dimensional antenna radiation pattern measurements.

For example, as a peak of a beam-steerable antenna array's radiation pattern sweeps past a bearing at which a UE is located, a received signal strength as measured at a receiver connected to the array's output terminals would typically initially increase, then peak and finally decrease as a lobe (either a main lobe or a side-lobe) of the antenna's radiation pattern encounters and then passes a bearing at which a UE is located. Likewise, as a null in a beam-steerable antenna array's radiation pattern sweeps past a bearing at which a UE is located, a received signal strength as measured at a receiver connected to the array's output terminals could initially decrease, then reach a minimum and finally increase as a null (for example between a main lobe and a side-lobe) of the antenna's radiation pattern encounters and then passes a bearing at which a UE is located.

Values of received signal strength obtained during the above sweep or sweeps may be recorded and then analysed to locate either or both of peaks or nulls in the signal strength values obtained. Since angular locations of these peaks and nulls of the antenna radiation pattern derived from received signal strength measurements from or by a UE are therefore known and the angles from boresight or the plane of the beam-forming antenna array (or any other fixed reference point) at which such peaks or nulls would be expected to occur relative to a known datum (for example the boresight direction of the antenna array) are also known, for example from design simulations of the antenna array or from measurements conducted upon one or more prototypes of the antenna array, it is possible to relate the angular locations of the peaks or nulls (or both) obtained in the beam-sweeping process to the measured or simulated locations of those peaks or nulls (or both) from the original antenna design or prototype. For example, if the highest value of received signal strength received during a complete sweep of the antenna, whilst searching for a UE, is obtained whilst the highest-gain point (‘peak’) of the main lobe is at a main lobe bearing of say 80 degrees from the plane of the antenna array, then it follows that the UE is located at a bearing of approximately 80 degrees from the plane of the antenna array. The relationship between a bearing at which a gain of a main lobe reaches its highest value and a corresponding beam-steering angle set by a controller and stored in conjunction with a signal strength measurement taken at this beam-steering angle may be derived from, for example, design simulations or measurements conducted on one or more prototype beam-steering antenna systems.

Alternatively (or additionally), if a lowest value of received signal strength received during a complete sweep of a beam-steering antenna array, whilst searching for a UE, is obtained whilst the lowest-gain point (i.e. deepest null) of its radiation characteristic is at a bearing of say 60 degrees from a plane of the antenna array, then it follows that the UE is located at a bearing of approximately 60 degrees from a plane of the antenna array; the relationship between a bearing at which a gain of a beam-steering antenna system reaches its lowest value and a beam-steering angle set by a controller and stored in conjunction with a corresponding signal strength measurement may be derived from, for example, design simulations or measurements conducted on one or more prototype beam-steering antenna systems.

A sweep of an antenna beam such as that illustrated in FIG. 13(a)-(d) can also, typically, be reversed once partially or wholly undertaken, in order to return a main lobe of a beam-steered antenna array to initial bearing 1307 or to any other prior angle. Alternatively, sweeping could commence from final bearing 1312 in FIG. 13(d) with a direction of sweep opposite to that shown by dotted-line arrow 1306 in FIG. 13(a). Indeed, sweeping could begin at any point and end at any point and proceed in either a clockwise or an anti-clockwise direction (based upon the orientation of the beam-pattern shown in FIG. 13) and even change direction one or more times within a given sweep, in order to gain additional receive signal strength measurement data for one or more particular areas of interest, in order to facilitate averaging of the received signal strength values obtained, for example.

Whilst the above examples have described searching for either a highest gain point of an antenna array or a lowest gain point of an antenna array, it is possible to search for other gain values or, more powerfully, for known sequences of gain values, based upon their correlation with changes in measured received signal strength values. For example, it is possible to search for a sequence of signal strength values which increase rapidly, then more slowly to a peak, before decreasing slowly and then more rapidly to a low level; this would clearly indicate a lobe in an antenna pattern and if the angular ‘width’ of this lobe matched a known width of a main lobe, then it would be clear in which direction a UE was located, based upon the angular location of a peak value calculated (or predicted) for this lobe. Note that it would not be necessary to obtain a signal strength measurement at the absolute peak of this lobe, the location of the peak could be inferred by calculation, based upon a known (previously measured) shape of the lobe, by means of a pattern-recognition, correlation or curve-fitting algorithm, as is known in the art.

The above discussion was based upon the angular location of a UE by a single steerable antenna array; clearly this will result in a quasi-linear locus of possible UE locations, for the reasons discussed above in relation to FIG. 5 to FIG. 10. The same or a similar beam-sweeping process just described may also be applied to a second, independent, orthogonal steerable antenna array and a second, orthogonal, angular location of a UE may be obtained, typically simultaneously with the first. Again this second angular location will result in a quasi-linear locus of possible UE locations, when considered in isolation. If, however the two loci, one obtained from a first steerable antenna array and another from a second, orthogonal (or at least non-parallel), steerable antenna array, are intersected, then a point of intersection can typically provide a single, accurate, location for a UE.

FIG. 14 shows a flowchart representation of a ‘peak-search’ method of locating a UE, of a form discussed above. The method starts at step 1401 and continues to step 1402 in which an antenna beam is steered or switched to a starting position (angle), for example a position similar to that illustrated in FIG. 13(a) or any other suitable position. The method then moves to step 1403 in which a signal strength level at the current beam position is measured by a receiver connected to the antenna array or by any other suitable means; a measured signal strength value and an associated beam position angle at which it was measured are both stored in memory store 1404.

The method then moves on to decision step 1405 in which the current beam position (angle) is checked to see if it is the intended final beam position for a given beam sweep. If so, the method moves on to step 1407; if not, then further beam positions are required within the sweep and the method moves to step 1406. In step 1406, the current beam position (angle) is incremented to the next step in the sweep. The step size used is typically a fraction of a degree, for example one-tenth of a degree or one-quarter of a degree, although any suitable step size may be chosen. Once the beam's position has been incremented, the method resumes at step 1403 where a signal strength obtained at that beam position is measured and recorded, as described above. Again the current beam position (angle) is checked, in decision step 1405, to see if it is the intended final beam position for a given beam sweep and if so, the method moves to step 1407.

In step 1407 the signal strength data retained in store 1404 is analysed to find the highest value of signal strength recorded during a complete sweep from the starting position to the final (or end) position. In step 1408 the beam position (angle) at which this highest value of signal strength was recorded is reported as an approximate angular location or bearing of a UE in a plane in which the antenna's beam pattern was swept, relative to a datum set for the system, for example a plane of the antenna array or boresight for a main-lobe of the antenna array, assuming that a peak gain of the main lobe occurs in a boresight direction of the antenna array or at a known offset which can be corrected for in the reporting process. The method ends at step 1409.

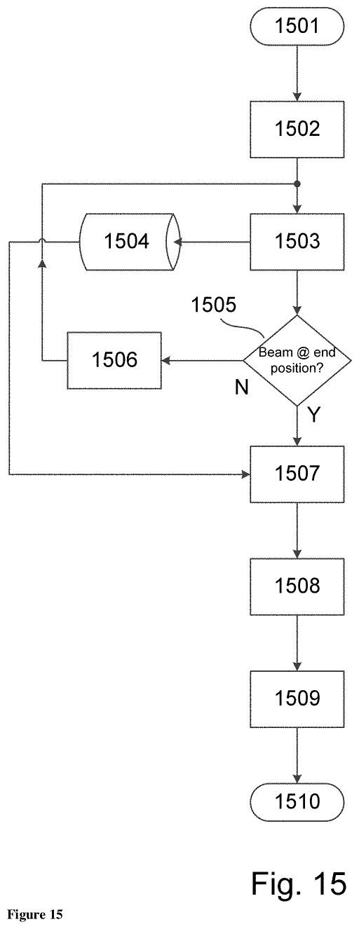

FIG. 15 shows a flowchart representation of a ‘null-search’ method of locating a UE, also discussed above. The method starts at step 1501 and continues to step 1502 in which an antenna beam is steered or switched to a starting position (angle), for example a position similar to that illustrated in FIG. 13(a) or any other suitable position. The method then moves to step 1503 in which a signal strength level at the current beam position is measured by a receiver connected to the antenna array or by any other suitable means; a measured signal strength value and an associated beam position angle at which it was measured are both stored in memory store 1504.

The method then moves on to decision step 1505 in which the current beam position (angle) is checked to see if it is the intended final beam position for a given beam sweep. If so, the method moves on to step 1507; if not, then further beam positions are required within the sweep and the method moves to step 1506. In step 1506, the current beam position (angle) is incremented to the next step in the sweep. The step size used is typically a fraction of a degree, for example one-tenth of a degree or one-quarter of a degree, although any suitable step size may be chosen (including non-linear step sizes). Once the beam's position has been incremented, the method resumes at step 1503 where a signal strength obtained at that beam position is again measured and recorded, as described above. Again the current beam position (angle) is checked, in decision step 1505, to see if it is the intended final beam position for a given beam sweep and if so, the method moves to step 1507.

In step 1507 the signal strength data retained in store 1504 is analysed to find the lowest value of signal strength recorded during a complete sweep from a starting position to a final (or end) position. In step 1508 a known angular difference between the deepest null (i.e. the position of minimum antenna gain within the antenna array's radiation pattern) and the antenna's datum point (e.g. a plane of the antenna array or a boresight direction of the antenna array) is used to calculate an angle at which a UE is likely to be located relative to the antenna's datum point. In step 1509, an angle calculated in step 1508 is reported as an approximate angular location or bearing of a UE in a plane in which the antenna's beam pattern was swept. The method ends at step 1509.

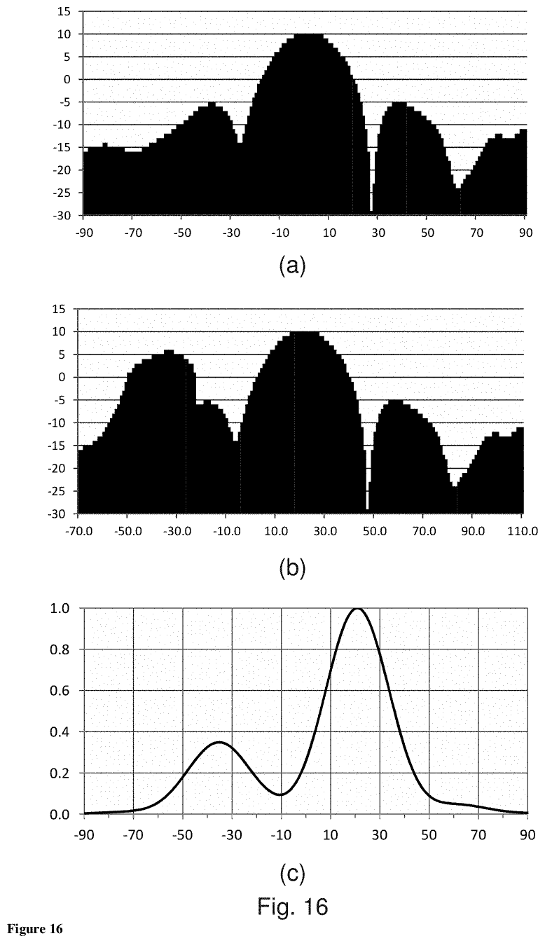

The graphical representations of the antenna radiation patterns (or beam patterns) discussed above in this disclosure, for example those shown in FIG. 6, FIG. 11 and FIG. 13 have all been plotted utilising a polar co-ordinate system as this provides a good visualisation of the antenna array as a quasi-point source (when considering, in particular, the far-field radiation of the antenna) and a good indication of how the electromagnetic energy radiated by the antenna array spreads out into its coverage space. It is possible, however, to plot an antenna's characteristics in a Cartesian form, such as is illustrated in FIG. 16(a) and this form of visualisation can be useful when accurately comparing antenna pattern characteristics. Comparing antenna pattern characteristics from a known characteristic, for example one obtained on an antenna measurement range, with an antenna beam when fixed (un-steered) such that its main-lobe is located in an antenna boresight direction or steered such that its main-lobe is located in an antenna boresight direction, with one obtained from a UE in an active, deployed, system can enable an angular location of a UE to be determined, as will be discussed below with reference to FIG. 16.

In FIG. 16(a), the horizontal axis shows an angular position measured in degrees relative to a boresight position of an antenna array and the vertical axis shows a gain, typically expressed in dB, of an antenna array relative to a reference level of gain, where the reference level of gain is typically chosen as an ideal isotropic radiating element, resulting in a gain expressed in units of dBi. Note that the antenna radiation pattern shown in FIG. 16(a) is that measured from a real physical example of a four-element antenna array which has been constructed and then measured using an antenna measurement range, with the results being quantised to a minimum of 1 dB steps which is similar to the signal strength measurement resolution of a typical receiver located in a Wi-Fi access point; FIG. 6, FIG. 11 and FIG. 13, in contrast, showed idealised approximations of one or more antenna array radiation patterns.

FIG. 16(b) shows a Cartesian representation of a steered antenna array radiation pattern, with its horizontal axis showing the angle in degrees relative to an un-steered boresight direction for the antenna array, where the un-steered boresight direction is zero degrees and its vertical axis shows the antenna's gain in dBi. The antenna radiation pattern shown in FIG. 16(b) is a modified version of the antenna radiation pattern shown in FIG. 16(a). This radiation pattern is taken from the same antenna array, however it has been modified in three ways: firstly, the resolution of the measurement system has been artificially reduced to a step size of 1 dB to correspond to a typical resolution of a received signal strength measurement in a low-cost receiver system, such as that present in a typical Wi-Fi access point; secondly, the radiation pattern has been shifted such that the main-lobe peak now no longer corresponds to the original boresight position, with this new position corresponding to the situation where the signal being received is not located at the un-steered boresight location of a steerable antenna array but at a new position offset from the un-steered boresight position of the array; thirdly, the pattern has been modified in a manner typical of what could happen in a ‘real-world’ environment, such as within a building or in a plaza surrounded by buildings. Such modifications could include a reduction in the depth of the ‘nulls’ in the radiation pattern and an increase in the size of side-lobes and the addition of further side-lobes all of which can result from, for example, signal reflections from surrounding structures or vehicles. In other words, as can be seen in FIG. 16(b), the pattern is now somewhat different to the more ‘ideal’ pattern shown in FIG. 16(a), although even this pattern is far from perfect, in that it is not symmetrical about its boresight angle and nor does it have especially low side-lobe levels.

The example beam pattern shown in FIG. 16(b) represents a swept measurement undertaken upon a UE which is positioned approximately 20 degrees away from an un-steered boresight of a steerable antenna system and when limited to a resolution of 1 dB for a received signal strength measurement employed in a receiver used for taking the measurement. A receiver used to make this measurement would typically form a part of a Wi-Fi access point, cellular communications receiver, public safety communications receiver or other radio communications receiver. Whilst the example beam pattern shown in FIG. 16(b) has been measured using the same angular resolution and the same signal strength resolution as that of the reference antenna measurement, shown in FIG. 16(a), this need not be the case. Indeed in a typical scenario, a coarse estimate of the location of the UE may be made utilising a relatively small number of measurements taken at relatively widely spaced angles, for example measurements taken every 10 degrees over a range of +/−50 degrees from the un-steered boresight direction. The use of a correlation based technique, as will be discussed, enables a useful measure of geolocation to be achieved even from a relatively sparse set of data such as may be obtained when using a coarse angle step size.

The example reference antenna characteristic shown in FIG. 16(a) and the example deployed antenna characteristic obtained, for example, from measurements of signal strength from a UE located within a coverage area of the antenna system and shown in FIG. 16(b), may be compared in order to determine the angular separation of the UE from the antenna's boresight position. One example of a means by which such a comparison may be undertaken is that of correlation. In one example of a correlation process, known as sliding correlation, one data set, say a reference antenna characteristic data set, is successively multiplied with a second data set, say that of a deployed antenna characteristic obtained from measurements of a UE to be located by the system. This successive multiplication may be achieved as illustrated in the following non-limiting example. A first example data set, Data Set #1, has 100 pairs of values, with each pair consisting of, for example, a beam angle relative to boresight and a corresponding normalised measure of signal strength, and a second example data set, Data Set #2, also has 100 pairs of values with each pair again consisting of, for example, a beam angle relative to boresight and a corresponding normalised measure of signal strength. The first data set could consist of beam angles and corresponding normalised measurement values of signal strength measured in a controlled environment, such as antenna measurement range, and the second data set could consist of beam angles and corresponding normalised measurement values taken of the signal strength obtained from or by a UE in a deployed geolocation system. The normalised values in each case may be normalised with reference to the peak value of signal strength obtained from a given sweep of an antenna beam from one extreme of its coverage range to an opposite extreme of its coverage range. Whilst normalisation would typically be undertaken it is not essential to the correct functioning of the correlation technique described herein.

Each data set may then be appended with further null (zero) values such that during a sliding correlation process, when a valid data set value is multiplied with a null value (zero), the result is zero.

Data Set #1 may now be aligned with Data Set #2 such that none of the valid data points overlaps, i.e. that the highest numbered data point (point 100 in this example) of Data Set #1 is aligned with one data point location below the lowest numbered data point (point 0 in this example) of Data Set #2. In other words, Data Set #1 occupies data point locations −99 to zero and Data Set #2 occupies locations 1 to 100 with data point locations −99 to zero and data point locations 101 to 200 of Data Set #2 being set to zero and data point locations −199 to −100 and 1 to 100 of Data Set #1 being set to zero. Each normalised signal strength value at each data point location is then multiplied individually for example a signal strength value from Data Set #2 stored at data point location 1 would be multiplied with a signal strength value from Data Set #1 stored at data point location 1 and so on for all data point locations from 1 to 100 in this example. The results of these individually multiplied signal strength values are then added together to form a single result and this is assigned to a Correlation Data Set data point location 1. One data set is then shifted by one data point location, such that the valid (non-zero) data now begins to overlap and the process is repeated. In the above example, the pairs of values of angular separation from boresight and their corresponding normalised signal strength levels of Data Set #1 are moved such that a pair of values originally stored at data point location 1 would now be stored at data point location 2 and a pair of values originally stored at data point location 2 would now be stored at data point location 3 and so on for all of the values stored, with each normalised signal strength value from Data Set #1 then being multiplied with its corresponding normalised signal strength value from Data Set #2 and all resulting multiplied values summed with the summed result being stored at Correlation Data Set data point location 2. This process is then repeated for all values, i.e. it would be repeated a total of 100 times in this example.

Since each data point location corresponds to an angular position, typically defined relative to the antenna's boresight pointing angle, it is possible to relate the Correlation Data Set directly to an angular position relative to boresight and a graph may then be plotted of the value of the correlation result, at each angular location, as one data set progressively slides across the other, in this case as Data Set #1 slides across Data Set #2. A typical form of the resulting characteristic is shown in FIG. 16(c), in which the horizontal axis shows an angular position relative to a boresight position of the antenna array and the vertical axis shows a relative correlation value, with a peak correlation corresponding to a correlation value of one. It can be seen from this figure that a large and distinct peak occurs in the characteristic at an angular offset from boresight at which the centre of the highest signal strength peak occurs in FIG. 16(b), even though the limited resolution of the signal strength measurements used (1 dB) means that a number of adjacent angular measurements all result in the same value of peak signal strength, thus making it more difficult to ascertain precisely where the UE is located purely on the basis of peak signal strength. The angular location of the correlation peak typically provides a clear, single, angular location for a UE, despite the apparent distortions to an antenna's radiation characteristics which result from reflections and other practical effects when an antenna system is deployed in a cluttered environment. It is thus a very powerful angular geolocation tool.

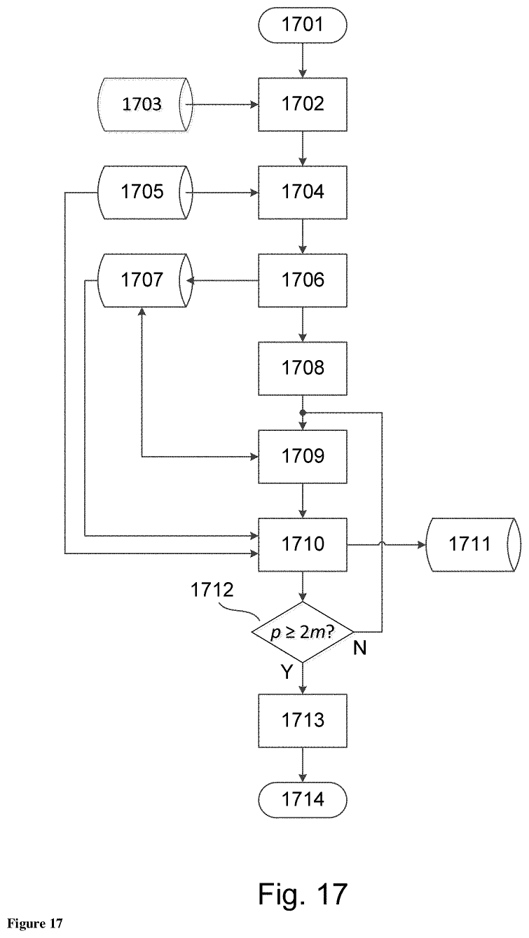

FIG. 17 illustrates a method for calculating the angular location of a UE relative to a known reference, according to one aspect of the present invention. The method starts in step 1701 and then proceeds to step 1702 in which a reference beam pattern, such as that referred to as Data Set #1 above, is loaded from data store 1703 and converted from logarithmic values (for example dBi or dBm) into linear units of gain (unitless) or power (for example measured in milliwatts or Watts) if required ready for processing by the algorithm. The algorithm assumes than any values not included in the loaded data representing the reference beam pattern are set to a small linear value or a zero linear value, when performing its subsequent processing.

The method proceeds to step 1704 in which a beam pattern, referred to as Data Set #2 above, which has been measured in-situ using, for example, transmissions from a UE being received by a wireless device employing a beam-steering antenna system, is loaded from data store 1705 and converted from logarithmic values (for example dBi or dBm) into linear units of gain (unitless) or power (for example measured in milliwatts or Watts) if required ready for processing by the algorithm. The algorithm assumes than any values not included in the loaded data representing the measured beam pattern are set to a small linear value or a zero linear value, when performing its subsequent processing; this is discussed further below in relation to the shifted reference antenna pattern data. Note that whilst step 1704 has just been described in terms of loading a beam pattern from a data store, it could equally well refer to the measurement of that beam pattern, in real-time, using an in-situ wireless device, based upon, for example, transmissions from or reported by a UE. This newly-measured data is then available for processing by the algorithm.

The method then moves on to step 1706 in which the data corresponding to the reference beam pattern is shifted a number of steps to the left (based upon FIG. 16(a), for example), i.e. its values are shifted in an angular sense negatively with respect to boresight such that the reference beam pattern and the measured beam pattern would have few or no valid points of overlap if they were plotted simultaneously on the same axes. The number of steps required to achieve this will depend upon the angular resolution with which the reference data set was measured or the desired number of steps to be used; for example it may be desirable to use a reduced version of the reference data set for the reference antenna pattern, taking for example every nth data point from the originally measured reference antenna pattern, where n is a positive integer greater than 1, in order to speed up the execution time of the algorithm. Taking the above example, discussed in relation to FIG. 16, the reference data set, Data Set #1, had 100 points. If this data set is used unchanged, i.e. it is not reduced as just discussed, then the number of steps by which the reference data set would be required to be shifted would be approximately 100; whilst more than 100 steps could be used, the additional steps would typically produce no benefit to the algorithm nor the precision of its result. The shifted reference pattern data is stored in Data Store 1707 along with a sufficient number of small or zero values either side to ensure that the subsequent correlation processing does not yield erroneous results. In the example discussed in relation to FIG. 16 above, at least 100 entries below the valid shifted reference pattern data and at least 100 entries above shifted reference pattern data would be required to be set to a small number or zero.

To summarise, the result of the above processing yields two data sets with the following characteristics:
1. A reference antenna pattern data set containing approximately 3 m storage locations, where the first m storage locations contain small or zero values of gain or signal strength, the second m storage locations contain linear values representing the reference antenna pattern typically in the form of gain or received signal power and the third m storage locations again contain small or zero values of gain or signal strength;
2. A measured antenna pattern data set, derived based upon the scanning or steering of a beam-steering antenna over a coverage area within which a UE, which it is desired to locate, is positioned, also contains approximately 3 m storage locations. Here, again, the first m storage locations contain small or zero values of gain or signal strength, the second m storage locations contain linear values representing the measured antenna pattern typically in the form of gain or received signal power and the third m storage locations again contain small or zero values of gain or signal strength.

In step 1708 a counter value p is defined and set to zero.

In step 1709, a copy of the shifted reference pattern data is retrieved from Data Store 1707 along with its attendant low or zero values, as just discussed. This data is then shifted one location to the right, i.e. to a less negative angle with respect to boresight, and the resulting shifted reference pattern data is stored back into Data Store 1707. The counter is incremented by one (i.e. p now equals one).

In step 1710, each of the 3 m data points of the measured antenna pattern data set is individually multiplied with a corresponding data point from the shifted reference pattern data set and the results of these multiple multiplications are summed together to form a single number. This correlation result value is stored in Correlation Store 1711, at location p, together with its corresponding beam angle, which is based upon the beam angle of the pth data point in the measured pattern data, where p is the value of the counter as noted above. Thus, for example, if the first data point in the original measured pattern data was taken at a beam angle of −45 degrees with respect to boresight, then the beam angle which would be stored along with this first correlation result value would be −45 degrees.

In this first iteration of the method, there is only one data point which will overlap between the two data sets, which is that of the upper end of the original reference pattern data set and the lower end of the original measured pattern data set, with all other points being, for example, zero, in one or other of the data sets.

In step 1712, the counter value p is compared to double the pattern length of the original reference pattern data set (prior to adding any low or zero values), i.e. 2 m; if p is greater than or equal to 2 m then the method moves on to step 1713, otherwise it returns to step 1709 and the section from 1709 to 1712 repeats.

At step 1713, the beam angle corresponding to the highest correlation result value stored in the Correlation Store 1711 is reported as a likely angular position or bearing of the UE relative to a boresight direction of the antenna array. The method then ends at step 1714.

Note that in step 1709 it is possible to shift the reference pattern data by a step size of greater than one, for example a step size of 10, in order to increase the speed of execution of the algorithm. The resulting estimate for an angular separation between boresight and a location of the UE may be poorer as a result of the larger step size, however it may be sufficient to provide an approximate location. The algorithm could then be run again, but utilising a restricted range of search angles, based upon the approximate angle derived in the first pass of the algorithm and an estimated error bound (for example +/−5 steps or +/−5 degrees) and a smaller step size, such as a step size of one, could then be used to more accurately locate the UE.

Likewise, the number of data points stored for the reference antenna pattern and the measured antenna pattern need not be the same. It may, for example, be advantageous to take fewer measurement points in order to form the measured antenna pattern, since the time taken to undertake these measurements will directly impact upon the time taken to provide an estimate of the location of a UE. In the case of a reduced number of data points being used, the method could either utilise a step size commensurate with the lower number of data points, for example using a step size of 10 in the case where the measured antenna pattern contains 1/10^{th} of the number of data points as the measured antenna pattern, or the step size could remain at 1, with all positions then being correlated, as previously, and some values yielding a null or neutral result.

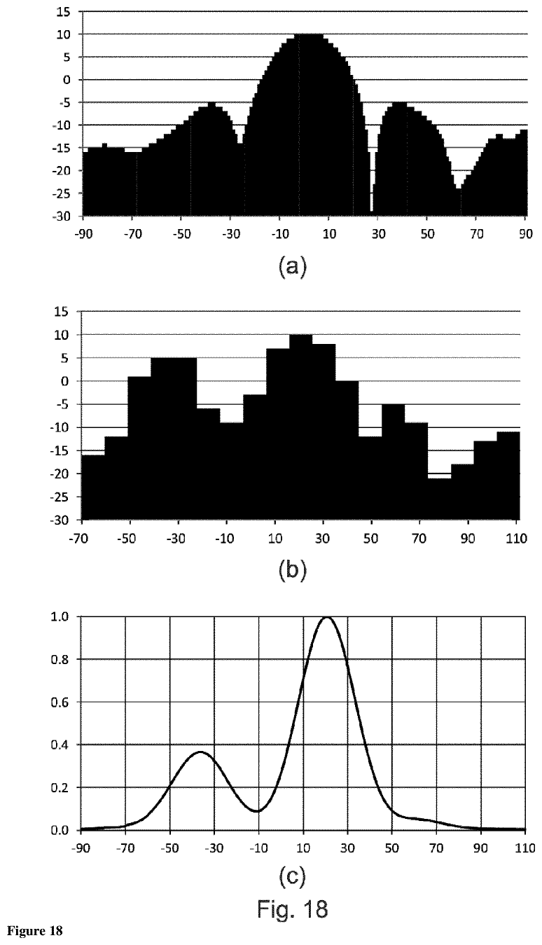

FIG. 18 shows an analogous situation to that of FIG. 16, with FIG. 18(a) being analogous to (and indeed identical to) FIG. 16(a), FIG. 18(b) being analogous to FIG. 16(b) and FIG. 18(c) being analogous to FIG. 16(c). The general situation illustrated is the same in both cases, being that of an antenna reference radiation pattern (FIG. 18(a)), a measured antenna radiation pattern based upon signals from a UE located approximately 20 degrees to the right of boresight (FIG. 18(b)) and a correlation characteristic resulting from correlating these two radiation patterns in the manner described above with reference to FIG. 16 and FIG. 17. The key difference between FIG. 18 and FIG. 16 is that FIG. 18(b) has been derived using 10 degree angular steps based upon measurements of a UE signal strength received at a steerable antenna array when steered in 10 degree steps, whereas FIG. 16(b) utilised 1 degree steps. Considering now the two correlation results, FIG. 18(c) and FIG. 16(c), it is clear that there is very little difference between them; both exhibit a clear peak at an offset from boresight of +20 degrees and both also exhibit a relatively sharp and well-defined peak, despite the very coarse angular resolution utilised in deriving FIG. 18(b). This figure clearly shows, therefore, that a relatively coarse angular step size may be employed, when sweeping a steerable antenna beam across an area in an attempt to locate a UE, with the resulting angular location estimate obtained when using a relatively coarse step size of 10 degrees being virtually indistinguishable from that obtained using a much finer step size of 1 degree. Thus a total number of angular measurement steps of under 20 can yield a similar angular location accuracy to that of approximately 180 steps or more, in this example. The above-discussed step sizes, angular resolutions and offset values are examples which illustrate the power of the correlation technique and should in no way be taken as limiting or even optimum values for any or all of these parameters.

The above discussion was based upon the angular location of a UE by a single steerable antenna array; clearly this will result in a quasi-linear locus of possible UE locations, for the reasons discussed above in relation to FIG. 5 to FIG. 10. The same or a similar correlation processing just described may also be applied to a second, independent, orthogonal steerable antenna array and a second, orthogonal, angular location of a UE may be obtained, typically simultaneously with the first. Again this second angular location will result in a quasi-linear locus of possible UE locations, when considered in isolation. If, however the two loci, one obtained from a first steerable antenna array and another from a second, orthogonal (or at least non-parallel), steerable antenna array, are intersected, then a point of intersection can typically provide a single, accurate, location for a UE.

Once a UE has been initially located, or if some a priori information is available to narrow down the range of possible locations for the UE, it is possible to apply the above correlation-based technique, or any other correlation or other UE search technique such as those further described below, over a narrower angular field of search. This could, for example, form the basis of a following or continuous tracking mechanism for the UE, whist taking far fewer processing resources and requiring far fewer signal strength measurements and hence data packets upon which to base signal strength measurements, in the case of a packetized radio system such as Wi-Fi. This, in turn, may make the location technique quicker and more responsive.

The above discussion has concentrated upon the use of a correlation technique based upon the use of the antenna main lobe; it is equally possible to base the technique upon one or more side-lobes or upon nulls in the antenna characteristic or any other combination of antenna radiation pattern characteristic features which can be matched between a reference antenna characteristic and a deployed-system antenna characteristic.

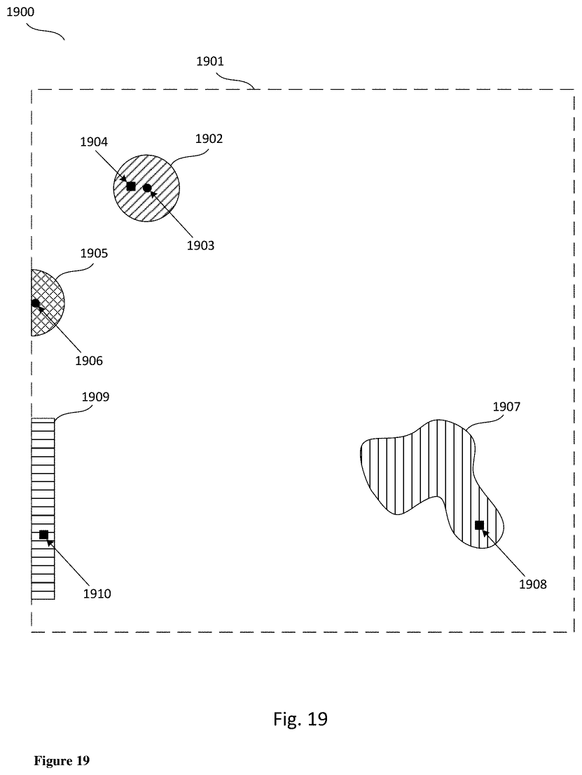

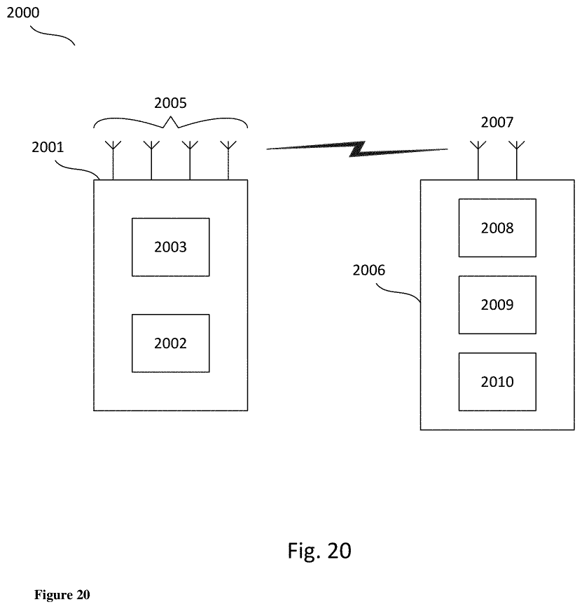

Turning now to the Bluetooth Low Energy (BLE) beacon aspects of the system, FIG. 19 shows a plan view 1900 of an example BLE beacon installation illustrating both conventional BLE beacons installed at two points 1903 and 1906 in an area of interest and two areas of ‘virtual’ BLE coverage 1907 and 1909, provided by a virtual BLE beacon system according to one aspect of the present invention. A coverage area for a wireless data system, for example a Wi-Fi access point, which is also a coverage area for a wide-area coverage BLE beacon is shown as area 1901; this area will be discussed in more detail in conjunction with FIG. 20 below.

Consider, first, conventional BLE beacons 1903 and 1906: beacon 1903 may be installed, for example, on a pole or rostrum and a resulting coverage area 1902 provided by that beacon may be omni-directional. A particular beacon or beacon code may be used to identify, for example, a location or area (as shown in FIG. 19) or it may be used to identify one or more objects, such as goods in a shop, with the beacon being physically relocated if the goods are relocated.

A UE, for example UE 1904, which is located within coverage area 1902 can receive short transmissions or notifications, often referred to as ‘pings’, from BLE beacon 1903 and may respond to or ignore these notifications depending upon whether they are considered to be of relevance by the UE. If, for example, UE 1904 has an installed program, which may be in the form of an ‘Ap’ or any other form of software program, and which is designed to respond to a particular notification, based upon an identification code contained within the short transmission from the beacon, then that program or another program could run or continue to run and, for example, convey a text message or graphical or audio-based message to the user of the UE, perhaps highlighting a special offer at a nearby store. If, on the other hand, the UE does not contain such an Ap or the content is not considered to be relevant to the user based upon his or her known preferences, then it may simply ignore the notification or ‘ping’.

The shape of coverage area 1902 from beacon 1903 is typically determined by radio wave propagation criteria, such as the frequency of operation, the power level of the transmission, antenna gain and radiation pattern, locally placed objects, persons or other ‘clutter’ and other, similar physical parameters. As a result, other than in terms of the radius of the coverage area 1902, a system designer or installer typically has very little control over the shape of the coverage area 1902. This is a significant disadvantage of installations consisting of physical, locally-placed, BLE beacons.

A second, typical, BLE beacon installation location is on a wall and this is illustrated by beacon 1906 and coverage area 1905 shown in FIG. 19. It can be seen from this figure that the beacon coverage area is now approximately semi-circular, in the plan-view shown in FIG. 19, and could be approximately hemispherical if a three-dimensional representation is considered. Again, a system designer or installer typically has very little control over the shape of coverage area 1905 (other than its radius).

In order to be able to realise an arbitrarily-shaped BLE beacon coverage area or coverage areas, a new approach is required. Consider, now, coverage area 1909; the area shown is approximately rectangular and could, for example, represent an area in front of a shop window, comprising an area within which the shop owner may wish to alert passing potential customers, such as user 1910, of special offers available in-store. Based upon beacon 1906 and its associated coverage area 1905, for example, designing a conventional beacon installation which could cover area 1909 exactly would be difficult to achieve and even an approximation to coverage area 1909 would be likely to require multiple, equally-spaced, beacons, adding to the costs of purchase, installation and maintenance (e.g. battery replacement) for the system.

Likewise, arbitrarily-shaped coverage area 1907 containing user 1908 could only be approximately covered by the use of multiple BLE beacons, for example of a similar design or construction to that of beacon 1903 and it may, indeed, not be possible to achieve such coverage at all by this means as there may be no suitable surfaces or structures to which hardware beacons could be attached. A virtual BLE beacon, as will be highlighted below, may be capable of forming a ‘bubble’ of coverage at an arbitrary point in space and which may have an arbitrary shape, without the need for a local structure upon which to mount a beacon or beacons in the immediate vicinity.

FIG. 20 shows the key elements of an example virtual BLE beacon system 2000 according to one aspect of the present invention. Virtual BLE beacon system 2000 consists of infrastructure radio equipment 2001 and user equipment (UE) 2006 wherein UE 2006 incorporates software module 2010 amongst other hardware and software modules.

Infrastructure radio equipment 2001 incorporates at least one Wi-Fi or other suitable radio module 2003, including associated software, processors, signal processing circuitry and the like, as are required to realise a functional radio transceiver system which is capable of geolocation. One example of such a geolocation system, based around a Wi-Fi radio system, has been described in detail above, for example in relation to FIG. 2 and other figures.

Infrastructure radio equipment 2001 also incorporates at least one wide-area Bluetooth low-energy (BLE) beacon module 2002 which may also be referred to as a broadcasting subsystem which is operable to broadcast BLE protocol-compliant signals over a coverage area and is operable to transmit a short data transmission or ‘ping’ wherein this data transmission may incorporate one or more digital identification codes which allow a given ping to be distinguishable from other similar pings, when received and decoded by a UE, for example.

Radio signals, which may include both Wi-Fi and Bluetooth signals, may be transmitted and, in the case of Wi-Fi signals, also received by antenna array 2005. Some or all of antenna array 2005 may also form part of a geolocation system. Wide-area BLE beacon module 2002 may, alternatively, utilise a dedicated antenna or antenna array. Infrastructure radio equipment 2001 is designed such that it can cover a large area where a large area is defined as an area much greater, perhaps ten or more times greater, than the local coverage of a single BLE beacon. For example, a local coverage radius of a typical BLE beacon may be 1-3 m (approximately 3.1 to 28.3 square metres); a typical beacon may be capable of covering a much wider area, however this is not generally considered to be useful in many applications as it loses the local association of a specific beacon with, for example, a specific, small, retail store, a part of a larger store or product display within a store. A typical UE application will therefore only accept a ‘ping’ from a BLE beacon if it judges that the received signal strength associated with the ping makes it likely that the UE is within 1-3 m of the beacon's location.

Wide-area BLE beacon 2002, together with its associated antenna or antenna array, is designed such that it is capable of providing an adequate level of signal strength over a relatively large area, for example coverage area 1901 shown in FIG. 19. This may require a higher level of transmit power than might typically be employed in a BLE beacon or it may involve the use of a higher gain antenna system, or it may involve a combination of both of these aspects. Equally, it may simply involve the design of a UE Ap which will accept a lower level of signal strength from a BLE ping, in conjunction with other information as will be outlined below, in order to ‘wake up’ that Ap and enable it to deliver information or other content to the user of the UE.

Radio and geolocation module 2003, which may be based upon one or more of the Wi-Fi protocols, is similarly designed to provide both radio coverage and an accurate geolocation capability over a similar or greater area than that of wide-area BLE beacon 2002. In the scenario illustrated in FIG. 19, for example, radio and geolocation module 2003 may be capable of serving an area greater than or equal to coverage area 1901. Thus, both radio and geolocation module 2003 and wide-area BLE beacon 2002 may be capable of simultaneously serving at least a desired coverage area, such as coverage area 1901.

Radio and geolocation module 2003 is capable of accurately spatially locating a UE, for example to an accuracy of 1 m or less in an appropriate percentage of attempts at spatial location of a UE, or any other level of accuracy which is deemed acceptable.

Radio and geolocation module 2003 may communicate a location of a UE to that UE using a radio bearer which lies within the operational capabilities of both units. For example, radio and geolocation module 2003 may communicate a location of a UE to that UE using Wi-Fi, perhaps in response to a request for its location from the UE. Thus a UE may know its location within a coverage area, such as coverage area 1901 of FIG. 19.

In addition, wide-area BLE beacon 2002 may transmit a short data transmission or ‘ping’ with the resulting signal covering, at an acceptable signal strength, at least a similar area to that within which radio and geolocation module 2003 is capable of both accurate geolocation and at least one of radio transmission and reception. UE 2006 may therefore receive both a ‘ping’ containing at least an identification code from wide-area BLE beacon 2002 using BLE radio receiver 2009 and one or more data messages containing information regarding the UE's location within the coverage area using radio module 2008, with antennas 2007 receiving either or both signals or a separate antenna (not shown) receiving the Bluetooth signals.

Software module 2010 contained within UE 2006 may receive both a numerical identification code from the received Bluetooth transmission, demodulated and decoded via the BLE radio receiver 2009, and location information regarding the UE's position from radio and geolocation module 2003 demodulated and decoded via radio module 2008. Software module 2010 can therefore utilise both the BLE identification code and the UE location information to decide whether a particular Ap or other functionality, possibly from a list of Aps or other possible actions, should be enabled to open, run or otherwise proceed in its execution. For example, if a BLE numerical identification code corresponding to a special offer in store A is received and the UE is located in a defined area close to store A, then software module 2010 may enable that special offer to be communicated to the user of the UE via an associated Ap or by any other means using, for example, a text message, an audio message or any other available mechanism.

If, however, a BLE message containing an identification code corresponding to a special offer in store A is received and the UE is located outside of the defined area within which store A's offers are to be communicated, then software module 2010 may prevent that special offer from being communicated to the user of the UE or simply ignore the identification code message.

Furthermore, if a BLE identification code corresponding to a special offer in store B is received and the UE is located in a defined area close to store A and outside of the defined area within which store B's offers are to be communicated, then software module 2010 may also prevent store B's special offer from being communicated to the user of the UE whilst in the proximity of store A.

While the features and functionalities for providing notifications to spatially-located fixed or mobile transmitting and/or receiving devices are primarily discussed with respect to the embodiments above, it should be appreciated that the features and functionalities of one embodiment may be similarly applied to other embodiments. Furthermore, although the embodiments described above do not require use of GPS technology, it may be readily appreciated that the features and functionalities described herein may be used in conjunction with such technologies as well.

In the preceding specification, various embodiments have been described with reference to the accompanying drawings. It will, however, be evident that various modifications and changes may be made thereto, and additional embodiments may be implemented, without departing from the broader scope of the disclosure as set forth in the claims that follow. The specification and drawings are accordingly to be regarded in an illustrative rather than restrictive sense.

At this point it should be noted that providing notifications to spatially-located fixed or mobile transmitting and/or receiving devices in accordance with the present disclosure as described above typically involves the processing of input data and the generation of output data to some extent. This input data processing and output data generation may be implemented in hardware or software. For example, specific electronic components may be employed in a spatial location module or a notification module or similar or related circuitry for implementing the functions associated with providing notifications to spatially-located fixed or mobile transmitting and/or receiving devices in accordance with embodiments described above. Alternatively, one or more processors operating in accordance with instructions may implement the functions associated with providing notifications to spatially-located fixed or mobile transmitting and/or receiving devices in accordance with embodiments as described above. If such is the case, it is within the scope of the present disclosure that such instructions may be stored on one or more processor readable storage media (e.g., a magnetic or optical disk or other storage medium), or transmitted to one or more processors via one or more signals embodied in one or more carrier waves.

In the above discussion, the term ‘processors’ includes any digital or analogue device which is capable of processing signals or data and includes, but is not limited to, microprocessors, Peripheral Interface Controller (“PIC”) processors, complex programmable logic devices (CPLDs), Application-Specific Integrated Circuits (ASICs), Field-Programmable Gate Arrays (FPGAs) and all similar or related devices.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

Persons skilled in the art will appreciate that numerous variations and modifications will become apparent. All such variations and modifications which become apparent to persons skilled in the art are considered to fall within the spirit and scope of the invention broadly appearing before described.

1. A wireless notification device for notifying user equipment within a coverage area, the wireless notification device comprising:
a beamforming subsystem,
a controller,
an antenna array,
a receiver, and
a broadcasting subsystem;
the beamforming subsystem being coupled to the controller, the receiver and the antenna array, the beamforming subsystem being operable to process RF signals received from the user equipment by the antenna array and to provide the processed RF signals to the receiver to form at least two virtual antenna lobes, wherein processing the RF signals comprises varying at least one characteristic of the RF signals in response to control signals from the controller to vary at least one pointing angle of the at least two virtual antenna lobes such that the at least two virtual antenna lobes intersect;
wherein the controller is operable to determine a location of the user equipment based on the processed RF signals received by the receiver;
the broadcasting subsystem being operable to disseminate an identification code within the coverage area.

2. The wireless notification device of claim 1 wherein the broadcasting subsystem and the wireless spatial location system utilise differing wireless standards.

3. The wireless notification device of claim 1 wherein the broadcasting subsystem comprises a Bluetooth or a Bluetooth Low Energy (BLE) transmitter.

4. The wireless notification device of claim 1 wherein the wireless spatial location system incorporates a transmitter, receiver or transceiver which operates according to a recognised Wi-Fi standard.

5. The wireless notification device of claim 1 wherein the antenna array comprises at least a first sub-array and a second sub-array wherein the second sub-array is oriented substantially orthogonally to the first sub-array.

6. The wireless notification device of claim 5 wherein the first sub-array is arranged to generate at least a first antenna lobe and the second sub-array is arranged to generate at least a second antenna lobe wherein at least one of the first antenna lobe and the second antenna lobe has a shape which is substantially elongate in one plane and substantially narrower in a second, orthogonal, plane.

7. The wireless notification device of claim 6 wherein the first antenna lobe and the second antenna lobe are arranged such that the plane in which the first antenna lobe is elongate is oriented substantially orthogonally to the plane in which the second antenna lobe is elongate.

8. The wireless notification device of claim 6 wherein the pointing angle of the first antenna lobe and the pointing angle of the second antenna lobe are controlled independently.

9. The wireless notification device of claim 1 wherein the controller further comprises a measurement system which is operable to measure one or more of the strength, quality or data transfer capability of a signal received by a receiver which is operably coupled to the controller.

10. The wireless notification device of claim 1 wherein the controller further comprises a data storage system which is operable to store one or more of the strength, quality or data transfer capability of a signal received by the user equipment and to report the said strength, quality or data transfer capability of the signal back to the controller.

11. The wireless notification device of claim 3 wherein the broadcasting subsystem further comprises an antenna element or antenna array wherein the antenna element or antenna array is shared with any other transmitter or receiver forming a part of the wireless notification device.

12. The wireless notification device of claim 1 wherein the broadcasting subsystem is operable to transmit a number of different identification codes and is reconfigurable either locally or remotely to effect a change of one or more identification codes which are transmitted by the broadcasting subsystem.

13. A method of notifying a user equipment within a coverage area, the method comprising:
processing RF signals received from the user equipment, to form at least two virtual antenna lobes,
wherein processing the RF signals comprises varying at least one characteristic of the RF signals in response to control signals to vary at least one pointing angle of the at least two virtual antenna lobes such that the at least two virtual antenna lobes intersect;
determining a location of the user equipment based on the processed RF signals; and
disseminating an identification code within the coverage area wherein the identification code is operable to notify the user equipment.

14. The method of claim 13 wherein the RF signals are received from the user equipment at least in part by means of an antenna array.

15. The method of claim 13 wherein the processing of the RF signals is undertaken at least in part within a beamforming subsystem.

16. The method of claim 13 wherein the identification code is received by the user equipment and wherein the user equipment undertakes or otherwise an action based upon the received identification code.

17. The method of claim 13 wherein the identification code is encoded within or otherwise utilises a Bluetooth or a Bluetooth Low Energy (BLE) carrier.

18. The method of claim 13 wherein the identification code identifies a physical object or item.

19. The method of claim 13 wherein the identification code identifies a location within the coverage area.

20. The method of claim 13 wherein the location of the user equipment is communicated to the user equipment.

21. The method of claim 20 wherein the location of the user equipment is wirelessly communicated to the user equipment by the wireless notification device.

22. The method of claim 13 wherein the broadcasting subsystem broadcasts a signal in accordance with at least an aspect of the Bluetooth or Bluetooth low-energy (BLE) standard.
